(19) United States
(12) Patent Application Publication
(10) Pub. No.: US 2015/0134864 A1
(43) Pub. Date: May 14, 2015

(54) SYNCHRONISATION OF A SYSTEM OF DISTRIBUTED COMPUTERS

(71) Applicant: CHRONOLOGIC PTY LTD, Adelaide, South Australia (AU)

(72) Inventor: Peter Graham Foster, Adelaide (AU)

(73) Assignee: CHRONOLOGIC PTY LTD, Adelaide, South Australia (AU)

(21) Appl. No.: 14/405,242

(22) PCT Filed: Jun. 3, 2013
(86) PCT No.: PCT/AU2013/000579

§ 371 Date: Dec. 3, 2014

Related U.S. Application Data
(60) Provisional application No. 61/654,934, filed on Jun. 3, 2012.

(51) Int. Cl. G06F 13/42

(52) U.S. Cl. CPC G06F 13/4286
USPC 710/106

(57) ABSTRACT

A method of determining a propagation time of signals from a USB Host Controller to an attached USB device is presented. In an embodiment, the method insludes: the USB device sending a message or data packet to the USB Host Controller; the USB device starting a local timer upon transmission of the message or data packet; the USB Host Controller responding to the message or data packet by issuing a handshake token; and the USB device stopping the local timer on receipt of the handshake token; wherein the local timer value represents twice the propagation time of signals from the USB Host Controller to the USB device.

This application claims priority from U.S. Provisional Patent Application Ser. No 61/654,934 filed on Jun. 3, 2012, the contents of which are to be taken as incorporated herein by this reference.

### FIELD OF THE INVENTION

The present invention relates to a method, apparatus and system for synchronizing the local clock of a computing device, such as a Personal Computer (PC), with a USB time domain and the time domain of an external clock.

### BACKGROUND OF THE INVENTION

Computer systems and the devices connected to them often require synchronisation with one another. This can be for many reasons.

In one exemplary scenario large computer simulations require the processing power of multiple computers. An example of such a system might be finite element analysis of the stresses on an airframe under certain test scenarios. In cases such as this, it is important that the processing rates on different computers are synchronised in order to maintain proper shared data flow and to minimise the calculation time of the model.

In another example, computational process virtualisation requires tight tolerances on the order that certain events are processed on a shared pool of computing resources. This is becoming increasingly important in many fields due to the trend in outsourcing of processing to banks of shared computers.

An example of this type of process virtualisation occurs in financial systems where there are strict requirements on the time sequence of financial transactions. This is becoming ever more important with the advent of high-speed financial trading systems, where improvements of the order of milliseconds can reap additional profits in the order of millions of dollars in fast moving markets.

Various methods have been developed over the years to synchronise the local time on a network of computers with varying degrees of accuracy.

Network Time Protocol (NTP) is a methodology for sharing Coordinated Universal Time (UTC) including scheduled leap second adjustments between computer systems. In NTP, no information about time zones or daylight saving time is transmitted; this information is outside its scope and must be obtained separately. NTP is designed to resist the effects of variable latency and can usually maintain time to within tens of milliseconds over the public Internet and can achieve 1 millisecond accuracy in local area networks under ideal conditions.

NTP is generally supported in Linux, BSD, MacOS X and Solaris, but not in Windows. All Microsoft Windows versions since Windows 2000 include the Windows Time Service which has the ability to synchronisation the computer clock to an NTP server. However, the version in Windows 2000 only implements Simple NTP—with reduced accuracy. Windows Server 2003 onwards offers time distribution algorithms that are similar to NTP, but the Windows Time Service cannot maintain the system time very accurately. The accuracy of the W32Time service is not guaranteed between nodes on a network.

IEEE-1588 is the standard for PTP, the Precision Time Protocol. This is a more recent time protocol where boundary clocks are introduced to the network to compensate for variable packet transmission delays through the network. Under controlled conditions with a point-to-point network PTP can operate down to the tens of nanoseconds range, but in a wider yet still well controlled network implementation the accuracy is typically hundreds of nanoseconds and above.

Most recently time synchronisation across vast network distances has been achieved by implementation of a Global Positioning System (GPS) time code source at each node of the network. This provides the greatest accuracy in knowing the local time at each node as inexpensive GPS clocks are now capable of maintaining their local time to the order of a few tens of nanoseconds.

However the problem still remains how to get that highly precise GPS time code into the computer system with the lowest possible latency and hence time stamp transactions or events with the greatest accuracy.

One approach that has not been considered is the use of the computer's Universal Serial Bus (USB) for this application. The USB specification is intended to facilitate the interoperation of devices from different vendors in an open architecture and there have been numerous attempts to synchronise a plurality of USB devices.

U.S. Pat. No. 6,343,364 to Leydier et al. discloses an example of frequency locking to USB traffic, which is directed toward a smart card reader. U.S. Pat. No. 6,012,115 to Chambers et al. addresses the USB start of frame (SOF) periodicity and numbering for timing. U.S. Pat. No. 6,092,210 to Larky et al. discloses a method for connecting two USB hosts for the purpose of data transfer, by employing a USB-to-USB connecting device for synchronizing local device clocks to the data streams of both USB hosts.

While these patents go some way to providing a network of synchronised USB devices, or at least a network of syntonised devices (all clocks operating at the same frequency but with some considerable phase error across devices). U.S. Pat. 7,539,793 to Foster et. al. provides a truly synchronised network of USB devices. Foster et. al. describes a system whereby the local clock of the USB network are syntonised and then synchronised. Once syntonised, the method of Foster et. al. determines the relative propagation time of signals across the network from a common point high in the network tree to each of the attached devices. This allows a relative propagation time to be determined and hence the phase of each device adjusted to ensure clock synchronisation to a high degree of accuracy.

A limitation of this method is that it requires the use of a special piece of additional hardwarn (a special timing hub device) and the relative time is only known with respect to said timing hub, not the computer itself.

Prior art exists in the area of reducing the latency of one USB device triggering a response on another USB device attached to the same USB. For example Foster (U.S. Patent Application Number 2012/0066417) teaches a method of using circuitry to intercept upstream USB packets at some point in the network and issue downstream messages to the respective USB devices. Although this method removes the host computer's operating system latency it requires special apparatus to be inserted into the USB. The necessity for additional apparatus is a limitation of this approach.

Although the above is not intended to be exhaustive or to describe the common general knowledge in this area, it is clear that there are deficiencies in the current art.

Thus, it is a general aim of the present invention to provide a method that may be used to synchronise the clock or notion of time of a computer system with an external timebase and/or to provide timely delivery of information signals from one USB device to a plurality of other USB devices attached to the same USB.

The above discussion of background art is included to explain the context of the present invention. It is not to be taken as an admission that any of the documents or other material referred to was published, known or part of the common general knowledge at the priority date of any one of the claims of this specification.

### SUMMARY OF THE INVENTION

One or more embodiments of the present invention relate a method Of and apparatus for determining the propagation time of signals from a USB host controller to an attached USB device.

In a first aspect, the present invention provides a method of determining a propagation time of signals from a USB Host Controller to an attached USB device, comprising:
said USB device sending a message or data packet to said USB Host Controller;
said USB device starting a local timer upon transmission of said message or data packet;
said USB Host Controller responding to reception of said message or data packet by issuing a handshake token; and
said USB device stopping said local timer on receipt of said handshake token;
wherein said local timer value represents round-trip propagation time of signals from said USB Host Controller to said USB device.

It will be appreciated by those skilled in the art that while no transaction can be originated by the USB device, said USB device's message or data packet(s) are transmitted in response to a request from said USB Host Controller.

The propagation time of signals across USB has been assumed to be symmetrical in upstream and downstream propagation, which indeed proves to be correct in practise and as taught by Foster et. al (U.S. Pat. No. 7,539,793). There is also some latency associated with the USB Host Controller issuing said handshake token as was similarly taught by Foster et al. for USB device response latency. Therefore propagation time of signals from said USB Host Controller to said USB device is equivalent to half of, said round-trip time less said Host Controller response latency.

An embodiment of the present invention thus provides a method which may enable a USB device to be synchronised to a USB Host Controller without the use of any additional hardware such as the USB timing hub of Foster et. al (U.S. Pat. No. 7,539,793). As taught by Foster et. al, a periodic data structure, such as a start of frame (SOF) packet or isochronous timestamp packet (ITP), in a USB data stream transmitted from the USB Host Controller to the USB device may be used by the USB device to synthesise a local clock. The methods described in Foster et. al (U.S. Pat. No. 7,539,793) are hereby incorporated by reference. The USB device may then adjust the phase of its local clock using the propagation time determined as taught in the present invention (approximately half of the local timer value). Thus, the local clock of the USB device is synchronised in phase and frequency to the clock of the USB Host Controller.

If multiple USB devices are attached to the USB Host Controller, the method of the present invention may be used to synchronise the plurality of USB devices together. The method of the present invention allows determination of the relative phase offset or USB time (defined by SOF/ITP packet reception) at each of a plurality of USB devices with respect to the Host Controller time.

Embodiments of the present invention may provide advantages over the method described in Foster et. al (U.S. Pat. No. 7,539,793). Foster et. al requires the use of a special piece of hardware, namely a special USB timing Hub, interposed between the USB device and the Host Controller. The present invention does not require the use of additional devices or hubs, the propagation time measurement may be performed in the USB device itself.

Further, a method according to an embodiment of the present invention involves determining the propagation time from the USB Host Controller to the USB device, not from a point randomly selected between the Host Controller and the USB device. This may allow a more accurate determination of propagation time compared with the method of Foster et. al.

Another advantage of the present invention is that it may not consume USB bandwidth as does the method taught by Foster et. al (U.S. Pat. No. 7,539,793). The response data packet transmitted from the USB device to the USB Host Controller and the handshake token issued by the USB Host Controller back to the USB device may be part of an ordinary communication between the USB Host Controller and the USB device. A special packet need not be used. A method according to an embodiment involves, in effect, monitoring existing data traffic and using information in that data traffic in order to determine propagation time of signals.

Typically the handshake packet would be an ACK or NAK packet, but the USB device could use reception of any handshake packet to stop its timer.

In an embodiment, said response data packet sent from said USB device to said Host Controller comprises an intentionally corrupted data packet and said handshake token returned by said USB Host Controller comprises a not acknowledge (NAK) token.

In another embodiment, said response data packet sent from said USB device to said USB Host Controller comprises an ordinary data packet and said handshake token returned by said USB Host Controller typically comprises an acknowledge (ACK) token, or alternatively a not acknowledge (NAK) token. A NAK token would also be valid if the ordinary data packet became corrupted by normal transmission as would be appreciated by one skilled in the art of USB's fault tolerant protocol.

Furthermore said Host Controller may request the value of said timer and said USB device may then transmit the value of said timer to said USB Host Controller. The value of said timer may represent one such round-trip measurement or it may represent the accumulation of a known plurality of such round-trip measurements. In this case the USB Host Controller would know the absolute phase difference between its internal clock and the local clock of the synchronised USB Device.

As well as synchronising the USB device to the USB Host Controller, a method according to an embodiment of the present invention may also be used to synchronise a clock at a computer containing the USB Host Controller to an internal or external clock at the USB device. Steps for performing such synchronisation will be described in more detail below.

hi each of the above preferred embodiments, the determination of propagation time may be made on an intermittent or periodic basis. This allows determination of any change in propagation time which may occur due to changes in the electronics in the path, such as but not limited to thermally induced latency variations. The continually updated propagation time measurement ensures that the phase compensation of the local clock of an attached USB device, as determined in said local clock's time domain, remains accurate and can track any changes in the environment.

A method according to an embodiment of the present invention may further comprise statistically analysing timer values from each repetition of the method to obtain a statistically improved value of propagation time.

As described above, a method according to an embodiment of the present invention may be used to synchronise a plurality of USB devices together. Preferably said plurality of USB devices are syntonised to the same clock rate prior to their relative determination of the signal propagation time from said Host Controller. Consider the case where each of a plurality of USB devices are operated in their own time domain, each of which is independent of the others. A determination of propagation time by each of said devices is made in the local time domain of each of said plurality of USB devices.

This is subsequently used to determine the phase offset or time difference between said USB Host Controller and each of said respective USB Devices. If the local clock of one of said USB devices were to change, then the phase offset or time difference (measured in ticks of this errant local clock) applied to its notion of time would change, thus altering the phase relationship of said USB device to the Host Controller and subsequently to each of the other plurality of USB devices.

For this reason it is preferable that each of said plurality of USB Devices is syntonised to the same clock rate prior to said respective determination of propagation time. Preferably, said plurality of USB devices are syntonised to the clock rate of the USB Host Controller. Preferably still this is to be achieved via syntonisation to SOF packet reception, ITP packet timestamps, another clock signal delivered via USB signal wires, wirelessly or from an external source such as but not limited to a GPS time server.

Therefore another aspect of the present invention provides a method of determining the propagation time of USB packets from a USB Host Controller to an attached USB device, comprising:
syntonising the local clock of said USB device to the clock rate of said USB Host Controller; and
determining propagation time according to any of the methods disclosed in the present invention.

Furthermore, yet another aspect of the present invention provides a method of determining the propagation time of USB packets from a USB Host Controller to a plurality of attached USB devices, comprising:
syntonising the local clock of each of said plurality of USB devices to the clock rate of said USB Host Controller; and
determining the respective propagation time to each of said USB devices according to any of the methods disclosed in the present invention.

In a preferred embodiment, determination of said respective propagation time comprises:
said respective USB device sending a message or data packet to said USB Host Controller;
said respective USB device starting a local timer upon transmission of said message or data packet;
said USB Host Controller responding to reception of said message or data packet by issuing a handshake token; and
said respective USB device stopping said local timer on receipt of said handshake token;
wherein said respective local timer value represents round-trip propagation time of signals from said USB Host Controller to said respective USB device.

In a preferred embodiment, said handshake token comprises an acknowledge (ACK) token or a not acknowledge (NAK) token.

The USB Host Controller may request the value of said respective local timer and said respective USB device may then transmit the value of said local timer to said USB Host Controller. The value of said respective local timer may represent one such round-trip measurement or it may represent the accumulation of a known plurality of such round-trip measurements.

In each of the above preferred embodiments, the respective determination of propagation time may be repeated on an intermittent or periodic basis. Embodiments of the present invention may further comprise statistically analysing timer values from each repetition of the method to obtain a statistically improved value of respective propagation time.

According to yet another aspect, the present invention provides a method of synchronising a notion of time of a USB device to a timebase of the USB Host Controller to which it is attached, comprising:
determining the propagation time of signals from said USB Host Controller to said USB device according to any of the methods disclosed in the present invention; and
applying a phase correction to said local clock of said USB device depending on to said propagation time.

An embodiment of the present invention also provides a method of synchronising a notion of time of a plurality of USB devices to that of the USB Host Controller to which they are attached, comprising:
determining the propagation time of signals from said USB Host Controller to each of said plurality of USB devices;
said Host Controller transmitting a notional time to each of said plurality of USB devices; and
each of said USB devices latching said notional time into a respective register upon receipt of a common specific USB packet.

An embodiment of the present invention also provides a method of synchronising a notion of time of a USB device to that of the USB Host Controller to which it is attached, comprising:
determining the propagation time of signals from said USB Host Controller to each of said plurality of USB devices;
said USB device receiving said notional time from said Host Controller;
said USB device latching said notional time into a register upon receipt of a specific USB packet; and
applying a phase correction to said local clock based on said propagation time.

An embodiment of the present invention also provides a method of synchronising a notion of time of a plurality of USB devices to that of the USB Host Controller to which they are attached, comprising:
determining the propagation time of signals from said USB Host Controller to each of said plurality of USB devices;
said Host Controller transmitting a notional time to each of said plurality of USB devices; and
each of said USB devices latching said notional time into a respective register upon receipt of a common specific USB packet.

Furthermore, the present invention provides a method of synchronising a notion of time of a plurality of USB devices to a timebase of the USB Host Controller to which they are attached, comprising:
repeating the above method for each of a plurality of attached USB devices.

Preferably, a local clock of each of the said plurality of USB devices is syntonised to the USB clock rate, prior to determination of said plurality of propagation times.

Another embodiment of the present invention provides a method of synchronising a plurality of USB devices, comprising:
syntonising local clocks of said plurality of USB devices to the USB clock rate; determining the propagation time of signals from said USB Host Controller to each of said plurality of USB devices;
advancing the phase of each of said local clocks by an amount equal to their respective propagation times;
said Host Controller transmitting a notional time to each of said plurality of USB devices; and
each of said USB devices latching said notional time into a respective register upon receipt of a common specific USB packet; and
clocking each of said notional time registers with said respective syntonised local clock.

Preferably said local clocks are syntonised by locking to a periodic data structure contained in the USB. Examples of suitable data structures include the USB SOF, or ITP packets.

Said USB local clock notions of times may be advanced by an amount equal to their respective relative measured propagation delay, thereby ensuring that each USB device is synchronised with the USB Host Controller.

Preferably syntonisation of the clock rate of said USB devices involves locking them to a periodic data structure contained in the USB traffic, in particular to the USB SOF packet or the Isochroous Timestamp Packet (ITP). Alternatively, syntonisation of the clock rate may involve locking said clocks to a common external clock reference or indeed directly using said common external clock reference.

Preferably said local timer of each of the respective USB devices is clocked from a clock source that is syntonised to the USB clock rate. In this case the common clocking reference ensures that phase offsets applied to each of the plurality of USB device clocks will remain consistent with one another (no relative phase change) and said plurality of devices will remain locked together in phase.

However if the clock rate of the Host Controller changes over time, the phase offset applied by each of said USB devices may change in absolute terms. This is a result of the absolute phase offset being determined in ticks of the propagation measurement clock, which may be syntonised to the Host Controller. As a result the absolute phase of the local clocks of each of said plurality of USB devices may vary with respect to the Host Controller clock or notion of time.

Therefore, the determination of propagation time may be made on an intermittent or periodic basis in order to ensure that the phase compensation of the local clock of an attached USB device, as determined in said local clock's time domain, remains accurate.

According to another aspect of the present invention there is provided an apparatus for measuring a round trip time (or period) of USB transactions between a USB device and a USB Host Controller, comprising:
circuitry for attaching to a USB;
circuitry adapted to transmit a data packet to said Host Controller across said USB; and
counter/timer circuitry for measuring a round trip time comprising a period of time between transmission of said data packet and reception of a designated response from said Host Controller.

Preferably said apparatus also comprises circuitry for syntonising the clock of said apparatus with the clock rate of the USB or Host Controller. In this way if a system containing a plurality of such apparatuses is attached to the same Host Controller, their respective measurements of round trip time will be made with synchronous clocks providing greater consistency and accuracy of relative round trip times.

In one preferred embodiment said circuitry adapted to transmit a data packet is able to intentionally corrupt said data packet. Said data packet may be corrupted by any of a number of means including deliberately corrupting any of the standard packet fields. In this case said apparatus expects said response packet to be a NAK packet.

For example, said circuitry adapted to deliver an intentionally corrupt data packets may operate in parallel with a conventional USB device circuit, wherein:
said circuitry monitors USB transactions between the USB Host Controller and said conventional USB device circuitry; and
said circuitry is adapted to clamp signal levels on the USB during transmission of certain packets in order to intentionally corrupt an otherwise normal data packet.

In another preferred embodiment, said handshake token comprises an acknowledge (ACK) token or a not acknowledge (NAK) token.

Preferably said measurement of round trip time is repeated and statistical means employed to improve the accuracy of said measurement. Said apparatus may also send the measurement of round trip period to said Host Controller.

Said circuitry is preferably located with the communication endpoint circuitry of said USB device.

Preferably said counter/timer circuitry is adapted to determine a period of time between reception of a pair of start and stop signals by being started by the transmission of a specified data packet and stopped by reception of the response packet from said USB Host Controller.

Preferably the circuitry also determines the propagation time of signals from said Host Controller to each of said apparatuses, being half of the respective round trip times.

Preferably said circuitry is operable to measure the roundtrip time of an acknowledge (ACK) or a not-acknowledge (NAK) packet associated with a particular transaction, whereby the relative phase of each device's local clock can be controlled so that all attached USB devices can be synchronized.

Another aspect of the present invention provides a system for determining a propagation time of signals from a USB Host Controller to an attached USB device (or plurality of attached USB Devices), comprising a USB Host Controller; and an apparatus according to any one of the embodiments described above.

Embodiments of the present invention also relate to a method of synchronising a computer system with an external timebase.

Accordingly, in another aspect of the present invention there is provided a method of mapping a notion of time of a computer to a notion of time of an external clock source, wherein said external clock source is connected to said computer via an interface to a USB Device, comprising:
a USB Host Controller of said computer transmitting a periodic or intermittent data structure to said USB device;
the USB Host Controller of said computer issuing an Interrupt upon transmission of said data structure;
creating a first timestamp in a time domain of said computer in response to said Interrupt;
said USB Device creating a second timestamp in a time domain of said external clock source upon reception of said data structure;
determining a propagation time of signals from said USB Host Controller to said USB Device;
applying a phase correction to either of said first timestamp or second timestamp to account for said propagation time; and
mapping said phase corrected first timestamp to said phase corrected second timestamp, thereby creating a relationship between a notion of time of the computer and a notion of time of the external clock source.

Preferably said external clock source or timebase is a globally accurate timecode such as Coordinated Universal Time (UTC) or GPS time. Preferably said external clock source is a reference clock such as a GPS Clock, IEEE-1588 clock, IRIG time code generator, NTP time source or other reference time source. Thus, the computer's notion of time may be correlated with a GPS or other reference clock notion of time.

However, said external clock source need not be a separate clock source. In another embodiment, said external clock source may be a local clock at the USB device. In this context an external GPS clock for example may be combined within said USB Device. By “external” clock source it is taken to mean external to the computer.

The data structure may be periodic in nature such as an SOF packet or an ITP packet, or intermittent in nature such as any message or data packet. The mapping may be between transmission or reception time of the periodic data structure. For example, to map transmission time, the first timestamp may be mapped to the first timestamp subtract the propagation time. To map the reception timestamp, the first timestamp plus the propagation time may be mapped to the first timestamp.

Preferably the time domain of said computer used to create said first timestamp is a time domain of said computer's highest resolution clock. Preferably still this is a monotonically increasing tick counter driven from a constant frequency clock.

A method according to an embodiment may further comprise said Host Controller measuring an interrupt latency value upon issuance of said interrupt, wherein said interrupt latency value is applied to said first timestamp before mapping to said phase corrected first timestamp. For example, the interrupt latency value may be subtracted from the first timestamp to obtain the actual time that the data structure was transmitted.

Determining a propagation time of signals from said USB Host Controller to said USB Device may comprise determining a propagation time in accordance with a method as described above. Alternatively, the propagation time may be determined using alternate methods, such as described in Foster et. al. (U.S. Pat. No. 7,539,793).

In an embodiment, the method may further comprise repeating the method multiple times to create multiple mappings between the notion of time of the computer and the notion of time of the external clock source. Each mapping may be related to a particular periodic data structure (e.g. SOF) frame number.

A method according to an embodiment may further comprise interpolating between the multiple mappings to determine a past time in the time domain of the computer corresponding to a past time in the time domain of the external clock source or vice versa. This enables, for example, the UTC time of an event that occurred at the computer to be determined using the computer's notion of time.

A method according to an embodiment may further comprise extrapolating from the multiple mappings to determine a future time in the time domain of the computer corresponding to a future time in the time domain of the external clock source or vice versa. This enables, for example, an event to be triggered at a future UTC time by triggering based on the extrapolated corresponding notion of time at the computer.

The interpolation and/or extrapolation may be computed using statistical techniques, as would be understood by the skilled addressee. These techniques could include creating a best fit to the plurality of individual determinations of the mapping between time domains. As such, errors or uncertainties associated with each of the individual determinations of time domain mapping could be reduced. The interpolation and extrapolation may also be used to determine the absolute time by reference to the computer's highest resolution clock.

Where the mapping is determined and stored at the computer, the method may further comprise said USB device transmitting said second timestamp and propagation time to said computer along with a frame number of said periodic data structure (e.g. SOF frame number). Alternatively, the mapping may be determined and stored at the USB device.

According to this aspect of the present invention, a computing device may be configured to control an external device, causing events to occur at specified times in the time domain of the external device. In a preferred embodiment, a mapping is created between the time domain of the computing device and the external device. The computing device determines when it wants to execute an event (the event time) in its own time domain and coverts that time to the time domain of the external device. The computing device then informs the external device of the specified time at which it wants said event to occur. The specified time may be communicated to the external device in either its own time domain or the time domain of the computing device (as the time domain mapping may occur in either of these locations). The external device then executes said event at said event time.

Similarly the process can operate in the reverse manner, whereby an external device determines when (in its own time domain) it wants a specific event (computation, trigger, command) to be executed in the computing device. In this case, the external device informs the computing device of the event time in either its own time domain or the mapped time domain of the computing device. At the designated time in the time domain of the computing device, it executes the required event.

In view of the above, an aspect the present invention provides method of a computing device executing a process in an external device at a specified time in the time domain of said computing device, comprising:
creating a relationship between the time domains of said computing device and said external;
determining an execution time of said process in the time domain of said computing device;
informing said external device of said execution time; and
said external device executing said process at said execution time.

An embodiment of the present invention also provides an apparatus for creating a mapping between the time domain of a computing device and the time domain of an external clock, comprising:
circuitry providing a USB Device function;
circuitry for receiving a clock signal from said external clock;
circuitry for timestamping the reception of periodic or intermittent data structures from a USB in the time domain of said external clock; and
circuitry for measuring a propagation time of signals from a USB Host Controller.

Another embodiment of the present invention provides an apparatus for creating a mapping between the time domain of a computing device and the time domain of an external clock, comprising:
circuitry providing a USB Device function;
said external clock;
circuitry for timestamping the reception of periodic or intermittent data structures from a USB in the time domain of said external clock; and
circuitry for measuring a propagation time of signals from a USB Host Controller.

According to another aspect, the present invention provides a method of and apparatus for synchronising a plurality of computer systems, their processes and attached devices may be synchronised to an arbitrary degree.

Another aspect of the present invention provides a method of synchronising a plurality of computing devices, each computing device being connected to a respective external clock source via an interface to a respective USB device comprising:
mapping a notion of time of each computer to a notion of time of its respective external clock source using any method as described above,
wherein each respective external clock source is synchronised to a common time. Thus a number of computers may be synchronised together despite being physically separated.

In this embodiment each computer system is connected to one of a plurality of synchronised time sources. Judicious choice of a source for said external timebase (such as, but not limited to, a GPS clock) allows said plurality of computer systems to be accurately synchronised on a wide, or even global scale. Therefore it is possible to synchronise the operation of a plurality of such computer systems.

Preferably said common time is a globally accurate timecode such as Coordinated Universal Time (UTC) or GPS time. Preferably said external clock source is a reference clock such as a GPS Clock, IEEE-1588 clock, IRIG time code generator, NTP time source or other reference time source.

In yet another aspect, the present invention provides a method of synchronising a plurality of computers, each computer being connected to a common external clock source via an interface to a respective USB device comprising:
mapping a notion of time of each computer to a notion of time of the common external clock source using any one of the methods described, above. Thus a number of physically proximate computers may be synchronised together to a common external clock source.

In an embodiment, the times of the local clocks of the computers may be actually controlled and modified to be synchronised to the notion of time of the external clock source. This may be achieved by controlling the frequency of a dedicated oscillator such that it operates at the same rate as said external clock, said dedicated oscillator being used as the clocking source for the system clock of said computers, thereby ensuring that the local clocks of the computers (or tick counters) operate in synchrony.

In another embodiment, the local clocks of the computers may not be modified, and instead the mapping may be used to determine a time in the time domain of the computer local clock that would be synchronised with a time in the time domain of the external clock source.

Similarly, in another embodiment, the periodic data structure rate of the Host Controller may be modified to be synchronised to the notion of time of the external clock source.

Yet another aspect of the present invention provides an apparatus for synchronising a notion of time of a plurality of computers to a common notion of time, comprising:
clock circuitry; and
a plurality of USB Devices, each USB Device comprising:
circuitry providing a USB Device function;
circuitry for timestamping the reception of periodic data structures from one of said plurality of computers in a time domain of said clock circuitry; and
circuitry for measuring a propagation time from said apparatus to a respective Host Controller of each of said plurality of computers;
wherein each of said computers establishes a USB connection to one of said plurality of USB Devices, each of said USB Devices timestamps reception of periodic data structures received from respective said computers, determines said round trip propagation time and provides said information to said respective computer.

Preferably said clock circuitry produces a globally accurate timecode such as Coordinated Universal Time (UTC) or GPS time. Preferably said external clock source is a reference clock such as a GPS Clock, IEEE-1588 clock, IRIG time code generator, NTP time source or other reference time source.

In another embodiment a plurality of computers are connected via USB to a common synchronisation device. In this embodiment one of the computers may be the master and all other computers may be synchronised to the timebase of said master computer. In this approach the synchronisation device maps the USB time, as defined by the USB Start of Frame (SOF) period or Isochronous Timestamp Packet (ITP), of each slave device to that of said, master device.

Still another aspect of the present invention provides a method of synchronizing a plurality of devices to the timebase of the computer system, comprising:
synchronising the local clock of each attached USB device to its reception of a synchronisation signal;
determining the propagation time of individual packets from USB Host to device; and compensating the relative phase of said local clock of each USB device in said tree according to said propagation times.

Wherein synchronisation signal is an SOF packet or an ITP packet or other reference time signal and said propagation time is determined by any of the methods taught in the present invention.

Also provided is a method of operating a distributed computing system in a synchronous manner. According to this method a plurality of computer systems may be deployed to perform a single computationally complex process where the subsystems are interdependent and highly time critical.

In another aspect, the present invention provides a method of low latency trigger distribution between USB devices attached to the same USB. A method according to this aspect relies primarily on a novel application of anomalous-protocol detection for rapidly distributing knowledge of a state of a USB device to other devices within the USB.

Accordingly, another aspect of the present invention provides a method of distributing low latency combinatorial triggers between a plurality of USB Devices attached to a USB, comprising:
designating a selected first plurality of USB devices as a plurality of trigger devices;
each of said plurality of trigger devices distributing their respective trigger signals;
each of said plurality of USB Devices monitoring said USB for respective trigger signals; and
each of said plurality of USB Devices creating a local event or trigger on reception of their respective combinatorial trigger.

In one embodiment comprising a plurality of USB devices, a chosen USB device is designated as a trigger generating device and is required to deliver a low latency signal (indicative of an event trigger) to one or more of said other USB devices. This embodiment utilises the USB Specification's data structure in a unique way. Handshaking is a standard part of the USB protocol to ensure correct deliver of data in some transmission modes, including Bulk Transfer mode. If a packet is corrupted somewhere in the delivery chain the receiving node reports to the transmitting node that a packet has not been received intact. This is required in order to complete a single USB transaction.

The USB Specification defines that data packets sent from the Host Controller to a particular endpoint address on a particular USB device are configured with either a DO token (data 0) or a D1 token (data 1). Furthermore the specification defines that successive tokens directed to the particular endpoint alternate between D0 and D1 states.

The USB Host Controller communicates to the attached plurality of USB Devices in a broadcast fashion. Headers in each data packet sent from said Host Controller inform each of said plurality of USB Devices which Device and Endpoint the data is destined for. However the broadcast nature of USB communication means that every data packet is received by each of said plurality of USB Devices. The contents of said packet are simply discarded if the data is destined for another device. It is therefore possible to receive packets destined for another device and act on their contents.

According to a preferred embodiment when said trigger generating device wants to issue a trigger event (or deliver a trigger signal to said other USB devices) it simply reports to the Host Controller that a data packet received from the Host Controller has been corrupted. It doesn't matter which data packet the trigger device reports as corrupt and for the fastest response it will choose the next packet received after it wishes to issue said trigger event.

This forces the Host Controller's physical layer hardware to attempt to resend the same packet immediately. Resending the supposedly corrupt packet happens in hardware without any interaction with the host PC's software layers. This removes the PC's operating system and software layers from the response time and provides is the fastest possible (lowest latency) USB interaction.

When a data packet is corrupted, the Host Controller immediately resends the corrupt data packet, resulting in an unexpected and non-standard data stream. Under normal circumstances data packet tokens D0 and D1 alternate for data delivered to a given endpoint. If a corruption event occurs either the D0 token or the D1 token will be repeated and in very quick succession. The Host Controller issues the same repeated D0 or D1 token in the event that the trigger device intentionally (and falsely) reports a corruption event. Since this repeated D0/D1 token is broadcast to all attached devices, all USB devices that are looking for a repeated data token on that endpoint will be informed of a trigger event in the same packet structure.

The benefits are two-fold. Firstly, there is no lower latency mechanism for a first device indicating an event to a second device than for the second device to be monitoring the transmissions to the first device's specific endpoint. Secondly, since each of a plurality of similar second device can monitor transmissions to said first device's specific endpoint, all devices receive the same indication in parallel and at substantially the same time (within the limitations of propagation path differences) as opposed to USB's standard sequential messaging approach.

Corruption events do occur naturally and may lead to false triggers but they are very rare. It is likewise rare that if a corruption event did occur, it would occur on the specific trigger USB device's chosen trigger endpoint. In order to further minimise the chance of false triggers, said trigger device may inform the Host Controller that several consecutive repeated packets have been corrupted causing the data token to be repeated not just once but several times. This would reduce the probability of false triggers multiplicatively (depending on the number of repetitions) but would also increase the latency in Trigger Event delivery. This would still have a latency orders of magnitude lower than relying on the prior art mechanism of messaging via the operating system.

Thus, according to this method, said usual response may comprise an acknowledgement (ACK) packet, and said alternate response may comprise a negative acknowledgment (NAK) packet, a corrupted data packet or no response at all. Said one or more USB devices monitoring said packets sent to said trigger device may monitor for an indicator packet with a repeated D0 or D1 header.

Another aspect of the present invention therefore provides a method of triggering a plurality of USB devices from a selected one of said plurality of USB devices attached to a USB comprising:
each of said plurality of USB devices monitoring USB traffic for packets designated for said selected USB device;
each of said plurality of USB devices detecting an anomalous data sequence transmitted by the Host Controller to said selected USB Device; and
each of said plurality of USB devices issuing a local event or trigger on detection of said anomalous data sequence.

In a preferred embodiment, each of said plurality of USB devices monitor USB traffic for packets designated for a specific endpoint of said selected USB device.

In a preferred embodiment said anomalous data sequence is a repeated D0/D1 token sequence to said specific endpoint of said selected USB Device.

Yet another aspect of the present invention provides a method of triggering a plurality of USB devices from a selected one of said plurality of USB devices attached to a USB comprising:
each of said plurality of USB devices monitoring USB traffic for packets designated for said selected USB device;
each of said plurality of USB devices detecting a change of Host Controller transmission state to said selected USB Device; and
each of said plurality of USB devices issuing a local event or trigger on detection of said anomalous data sequence;
wherein said change of Host Controller transmission state is in response to said designated trigger device changing a USB communication state, being indicative of said trigger device issuing a trigger message or signal.

In a preferred embodiment, each of said plurality of USB devices monitor USB traffic for packets designated for a specific endpoint of said selected USB device.

Still another aspect of the present invention provides method of triggering one or more USB devices attached to a USB Host Controller comprising:
designating a trigger device of the one or more USB devices;
the USB Host Controller sending packets to the trigger device;
the one or more USB devices monitoring the packets sent to the trigger device;
the trigger device responding to the packets with a usual response;
the trigger device detecting a trigger condition and responding to a next packet with an alternate response;
the Host Controller receiving said alternate response from the trigger device and sending an indicator packet to the trigger device; and
said one or more USB devices detecting said indicator packet sent to said trigger device, the indicator packet indicating the trigger condition.

A method according to this aspect of the present invention may further comprise: designating an endpoint of the trigger device; wherein said packets are sent from the USB Host Controller to said endpoint of said trigger device, and said one or more USB devices monitor packets directed to said endpoint of said trigger device.

A method according to this aspect may further comprise:
after detecting said trigger condition, said trigger device responding to a sequence of next packets with the alternate response;
said Host Controller responding to said sequence of alternate responses by sending a sequence of indicator packets to said trigger device;
said one or more USB devices detecting the sequence of indicator packets sent to said trigger device, the sequence of indicator packets indicating the trigger condition.

Accordingly, said one or more USB devices monitoring said data packets sent to said trigger device monitor may monitor for a sequence of unexpected data packets having a repeated D0 or D1 header.

In a typical prior art trigger delivery process the Computer must receive a first message (a trigger message) from a USB Device, decode the message, branch its code based on the message and then sequentially send a second message to each of the USB Devices that require delivery of notification that said designated trigger device has received its trigger event. This process can be delayed by an arbitrary amount depending on the operating system. Some operating systems such as Windows may decide to periodically sleep any of the processes depending on its own resource requirements. This could delay the delivery of a trigger message by a second or longer in extreme cases. Worse still some said plurality of second messages may be sent before said sleep cycle and others after it resulting in the trigger message being received by each of the plurality of USB Devices over a second apart.

There are still other ways to achieve this aim by utilising the USB Specification's inherent handshaking protocol in yet another unique way. One such mechanism utilises the USB PING packet. Before sending an OUT transaction to a bulk Endpoint, the Host Controller may send a PING packet. The response to the PING will be an ACK or a NAK. ACK means that the Endpoint is ready to accept an OUT transaction of maximum packet size for the Endpoint. NAK means that it is not ready. The host may continue to send another PING directly after a NAK, or it may choose to wait for a number of microframes before re-trying. Later Host Controllers implement PING-NAK throttling to reduce bandwidth consumption but this throttling mechanism can generally be switched off.

A further feature is that, after a successful OUT transaction, the endpoint may respond with ACK to indicate that it is already prepared to accept a further packet, or NYET to indicate that it received the data correctly, but is not yet ready to accept further data.

According to one or more embodiments of the present invention it is therefore possible for the USB Host Controller to issue a series of PING messages to a specified Endpoint on the Trigger Device. Said Trigger Device would be configured to respond with a NAK packet, this response would typically indicate that the Endpoint is currently full. This causes the Host Controller to try again, issuing another PING packet. The repeated PING may be sent immediately or may be scheduled to be sent after a number of microframes. This series of PING—NAK transactions continues while said Trigger Device sits in its ‘armed’ state waiting to receive the trigger event. When the Trigger Device is ready to issue its trigger signal or message to the USB it simply allows the Endpoint to respond to a PING message with an ACK packet, indicating that it is ready to receive Data from the Host Controller.

Meanwhile all other USB Devices are able to decode the PING packet that is addressed to said specified Endpoint of the Trigger USB Device. As soon as the Trigger Event occurs in the Trigger Device it enables and ACK response instead it a NAK response. This causes the Host Controller to stop issuing PING tokens and to issue its pending data packet, which may in fact be a single packet in this case.

In this way, when each of the other plurality of USB Devices are “armed” to receive the trigger they observe traffic addressed to said specific Endpoint of said Trigger Device. If they observe PING messages they continue to wait. Reception of a Data Packet (or in fact simply the cessation of PING packets) is equivalent to reception of their trigger message. This method is immune to the false triggers mentioned above with the repeated Data0/Datal packet mechanism. It can also react faster (as repeated transmissions are not required to indicate a trigger) but for minimum trigger latency it consumes a lot of bandwidth.

Therefore, in the method described above, the packets sent from the USB Host Controller to the USB device may comprise PING packets, with the USB Device configured to respond by issuing a not acknowledgement (NAK) packet and said alternate response may comprise an acknowledgement (ACK) packet. The indicator packet may comprise a packet with a D0 or D1 header (as opposed to a PING header).

This simple state change in said designated Trigger Device is mirrored by the Host Controller on the next transaction and subsequently each USB Device that has been “armed” to look for this state change (by virtue of the broadcast nature of USB) will also detect the state change on the next transaction.

In addition to delivering inter-USB-device trigger notifications with the lowest possible latency, the present invention supplements trigger notification with timestamps of the actual time that a given trigger event occurred. For example, a trigger event is recorded at a time t1 in the time domain of the designated trigger device. A plurality of other attached USB devices monitor Host Controller transactions addressed to a specified endpoint of said designated trigger device. At some time t2 after t1 each of said plurality of USB devices observe a change in the transmissions addressed to said specified endpoint (by any of the methods disclosed in the present invention), indicative of a trigger message. Said designated trigger device may subsequently send a message to the Host Controller containing said timestamp t1 which would subsequently be sent to each of said plurality of USB devices. In the event that each of said plurality of USB devices were synchronised they could relate said timestamp t1 to data stored in their own memories, potentially transmitting trigger-event correlated data back to the USB Host Controller.

Either the D0/D1 embodiment or the PING embodiment may be implemented on USB-3.0, by constructing a USB containing both SuperSpeed and non-SuperSpeed connections to each USB Device. There are various methods for achieving this. Communication may occur across the SuperSpeed channel while synchronisation and triggering may occur across the non-SuperSpeed channel. Data bandwidth can be maximised across the SuperSpeed channel while synchronisation (syntonisation to reception of SOF packets and synchronisation via any of the methods of the present invention or known prior art of Foster, for example U.S. Pat. No. 7,539,793, International Patent Application No PCT/2007/000155) and triggering (via any of the methods taught in this disclosure) can occur across the non-SuperSpeed channel. In this way a plurality of Trigger Devices can each operate on the non-SuperSpeed channel at maximum speed, together consuming the total bandwidth of the non-SuperSpeed channel maintaining the minimum possible latency while not impacting the data throughput of the SuperSpeed channel.

According to another embodiment, the present invention provides a method of performing combinatorial low latency triggers. While any such anomalous-protocol process may be applied as taught in the present invention, the current discussion relates to the PING-NAK preferred embodiment described above. Each of a first plurality of Trigger Devices are configured to respond to a PING message with a NAK. That is, each of them are in the “armed” state. Each of a second plurality of USB Devices (which may or may not include some of said first plurality of USB Devices) are configured to decode USB traffic to specific Endpoints on each of said first plurality of USB Devices. Each of said first plurality of USB Devices issue a Trigger Signal by responding to a PING by sending an ACK instead of a NAK, causing the Host Controller to send a Data packet to each of said first plurality of USB Devices that have responded with an ACK.

Each of said second plurality of USB Devices deem each of said first plurality of USB Devices to have issued a Trigger Signal when each of said second plurality of USB Devices detect a Data D0/D1 packet addressed to said specific Endpoint of each of second plurality of USB Devices.

Each of said second plurality of USB Devices wait for specific combinations of trigger signals from said first plurality of USB Devices before determining that said combinatorial trigger has been received. It should be noted that each of said plurality of USB devices may be configured to respond to a different combinatorial trigger.

A method according to an embodiment may also employ any method of utilising the handshake packets for low latency trigger delivery such as but not limited to, the Data0/Data1 method disclosed.

Another aspect of the present invention provides a trigger device for triggering one or more USB devices attached to a USB Host Controller comprising:
circuitry configured to respond to packets received from the USB Host Controller with a usual response until a trigger condition occurs;
circuitry for detecting a trigger condition; and
circuitry for acting on the detection of a trigger condition by responding to a next packet received from the USB Host Controller with an alternate response.

Preferably, the Host Controller receiving the alternate response from the trigger device sends an indicator packet to the trigger device, the indicator packet indicating the trigger condition to one or more USB devices monitoring the packets sent to the trigger device.

The trigger device may further contain circuitry to perform the different variations of the method for minimising triggering latency, as described above.

Another aspect of the present invention provides a system comprising:
a USB Host Controller;
a trigger device as described above; and
one or more USB devices, each USB device containing circuitry for monitoring packets sent from the USB Host Controller to the trigger device for an indicator packet, the indicator packet indicating a trigger condition.

According to yet another aspect of the present invention there is provided a method and apparatus for issuing trigger signals on external equipment (and timestamping events) with regard to the clock of the PC (Tick counter), the USB time domain (SOF or ITP based) or the timebase of an external clock. A plurality of these apparatus may be connected to a plurality of external equipment, and used to coordinate operations on the different external equipment.

Circuitry is able to determine the propagation time of signals across the USB from said Host Controller. Preferably this is by means of the first broad aspect of the present invention or any other appropriate means. This allows synchronisation of the time of each of a plurality of such Trigger

Devices, said plurality of devices then being able to operate in a time-coordinated manner. Said plurality of Trigger Devices could then operate to each output a signal from their respective I/O Connector with precisely aligned phase.

Accordingly, another aspect of the present invention provides an apparatus for providing timing information to external equipment comprising:
clock circuitry;
circuitry configured to syntonise said clock circuitry with a periodic data structure input into the apparatus from an external source;
circuitry configured to determine a propagation time of signals from said external source to said apparatus;
circuitry configured to adjust a phase of said clock circuitry based on said propagation time; and
a digital input output port for communication with said external equipment.

The apparatus may further comprise trigger circuitry for issuing trigger signals to said external equipment via said digital input output port. Alternatively or additionally, the apparatus may comprise timestamp circuitry for timestamping data received from said external equipment via said digital input output port.

Yet another aspect of the present invention provides a method for mapping between the time domain of the Host Controller (SOF or ITP time) and the clock of the personal computer itself (Tick Counter). Furthermore the present invention discloses a method for mapping these two time domains to an external time domain.

The computer can generate a trigger event or in fact initiate a sequence of operations that would deliver either a digital output signal at a given frequency or data rate or generate an analogue output signal of arbitrary nature. Using a plurality of said Trigger Devices would allow a plurality of such trigger events to be executed with high phase accuracy.

Similarly a method according to an embodiment can timestamp external events (or begin to record either an analogue or digital signal) with regard to the local USB time or the Computer's Tick time (and subsequently deliver this information to a system controller or other attached USB devices).

Another aspect of the present invention provides a system for trigger distribution including local USB device trigger identification, low latency notification of other USB Devices, combinatorial trigger determination, trigger timestamp distribution and performance of operations based on trigger and potentially timestamp distribution.

Although the above aspects of the present invention have been described in relation to USB, it will be appreciated that the concepts of the invention are equally applicable to other communications protocols and components. For example, the invention is applicable to Ethernet, PCI and other buses. Packets may be broadcast using these buses and processes implemented to achieve the advantages of aspects of the present invention.

In another aspect, the present invention provides a method of synchronising a network of USB measurement and control instruments with the master timebase of another instrument.

Still another aspect of the present invention provides a method of correlating data from a USB measurement/control instrument with data from a non-USB measurement/control instrument to which the USB measurement/control instrument is connected, comprising:
synchronising a local clock of the USB measurement/control instrument to an instrument clock signal transmitted from a clock port of the non-USB measurement/control instrument;
recording data with the USB measurement/control instrument and non-USB measurement/control instrument;
issuing a trigger signal from one of the USB measurement/control instrument and the non-USB measurement/control instrument to the other;
timestamping recorded data on issuance or receipt of the trigger signal; and correlating recorded data using the timestamps.

An embodiment of the present invention also provides an apparatus for correlating the data measured by a USB measurement instrument and a non-USB measurement instrument, comprising:
a USB device function;
circuitry for transmitting and/or receiving a clock signal indicative of a clock rate of a measurement instrument; and
circuitry for transmitting and/or receiving a trigger signal indicative of a phase alignment marker.

Modern laboratory instruments generally fall into one of two broad classes. The first class (typically budget equipment) contains an embedded control system which typically comprises a microcontroller, memory and ancillary circuitry. This is often a Commercial Off The Shelf (COTS) controller but will sometimes be a dedicated system optimised for the application. Typically this equipment contains a USB port for communication with other equipment.

The second class (typically higher end equipment) is built around a personal computer (PC) architecture. This type of equipment often contains a PC motherboard with the dedicated instrument functionality connected via the PC's standard expansion ports, such as but not limited to USB, PCI or PCI express.

An embodiment of the present invention provides a method of synchronising the timebase of the USB ports with, the measurement timebase of the instrument. There are many possible embodiments of this. Synchronising the local clock of the USB measurement/control instrument may comprise controlling and modifying the local clock to be synchronised in phase and frequency with the instrument clock. Alternatively, synchronising the local clock of the USB measurement/control instrument may comprise recording a mapping between a notion of time of the local clock and a notion of time of the instrument clock signal.

In a one embodiment, the USB Host Controller's Clock (referred to hereinafter as the USB Clock) is independent of the Instrument Clock. Typically the USB Clock has poor frequency control, the USB Specification only requiring accuracy to +/−500 parts per million (ppm) while the Instrument clock is often expressed in units of parts per billion.

In an embodiment, the Instrument Clock is delivered to a USB Device attached to the USB Host Controller. Said USB Device is able to synthesise a Local Clock from the USB Data stream (for example SOF or ITP) and create a map between its Local Clock and the Instrument Clock.

Preferably still synchronisation contains a phase measurement and correction process as taught in the present invention that aligns the Local clock phase to either the USB, the Computer's Tick Counter or an external clock. Thus, a method according to an embodiment of the present invention may further comprise applying a phase compensation to the timestamps at one of the USB or non-USB measurement/control instruments, to take account of a propagation delay in cable/s connecting the instruments.

Preferably said Instrument Clock is delivered from a dedicated Clock Output port. However a dedicated Clock output may not always be available, particularly with budget equipment. In this case the Instrument may have an alternative output port which contains clock information. An Oscilloscope typically provides a probe compensation port. This typically delivers a 1 kHz square wave output in order to allow fine tuning of the probe parameters for optimum performance.

Typically still said 1 kHz signal is derived from the Instrument Clock. Said 1 kHz signal can then act as a source of reference clock information for syntonisation of said attached USB Device. The clock port of the non-USB measurement/control instrument may thus comprise either a dedicated clock output port or a probe compensation port.

Furthermore a trigger signal is sent from the Instrument in order to align the phase of the Local Clock of the USB device (and hence the local clock of all attached USB Devices by reference to the USB Clock) to the phase of the Clock in the Oscilloscope.

In an alternate method of synchronisation the USB Device syntonises its Local Clock to either the Dedicated Clock output or the 1 kHz output as described above, but synchronisation is achieved by the Oscilloscope receiving a trigger signal from the USB device.

There are additional means of synchronising a USB time domain to that of an Instrument. For example the typically 1 kHz probe compensation output signal from an Oscilloscope may be modified. The present invention utilises a method whereby the 1 kHz signal, which is syntonised to the Instrument's master clock can be used by the USB Device as a syntonisation reference signal. Synchronisation may be defined to occur at a missing 1 kHz clock edge (ie where the trigger signal is defined by a circuit that clamps the output signal either in a logical high or low state for at least one cycle. Furthermore within such ‘clamped’ period a high frequency signal may be delivered that provides more accurate resolution of the trigger's time.

The present invention may provide for a high bandwidth multi-host USB. A multi-host USB system allows greater device count than a single USB Host Controller and greater total data bandwidth, but in order to correlate measurements from a plurality of measurement instruments across the plurality of hosts contained therein, each of said Host Controllers must be synchronised.

It is important that each of said Host Controllers operate at the same frequency because USB devices attached to each of the plurality of Host Controllers syntonise their clocks to the frame rate of said respective Host Controllers. Furthermore and non-obviously, each of said plurality of Host Controllers must synchronously initiate their frame counters because an attached USB Device's notion of time is related to the time at which it receives its respective numbered SOF tokens.

Another aspect of present invention provides a method of determining the propagation time of SOF tokens from each of said USB Host Controllers to each of said respective USB Devices, thereby allowing accurate control of the phase of each of said plurality of USB devices. Compared to prior art, the method and apparatus of the present invention does not require insertion of a message propagation measuring USB Hub.

In an additional preferable embodiment, an SOF comparison means is provided that measures the time of passage of said numbered SOF packets from each of said plurality of USB Host Controllers. Said comparison allows accurate phase compensation of each respective USB Host Controller's attached USB devices should said plurality of USB Host Controllers fail to initiate their frame counters synchronously.

It should be noted that the various features of each of the above aspects of the invention can be combined and are in fact intended to be combined in numerous embodiments of the invention.

The techniques described herein can be applied to many computer busses beyond USB and this application is not intended to be limited merely to the USB approach. For example, the techniques may be applicable to Ethernet, Firewire, lightpeak, thunderbolt, PCI, PClexpress etc.

Accordingly, another aspect of the present invention provides a method of synchronising a plurality of USB Devices with the clock source of a PXI rack, comprising:
operating the Host Controller of a USB with a reference clock derived from a PXI backplane;
determining a phase relationship between a PXI trigger and the frame counter of a USB Host Controller;
determining a propagation time of signals from each of said USB Host Controller to said respectiveplurality of USB Device; and
providing a phase adjustment of the local clock of each of said USB devices according to their respective propagation times and said phase relationship between said PXI trigger and the frame counter of said USB Host Controller.

In addition, apparatuses according to embodiments of the present invention can be embodied in various ways. For example, such devices could be constructed in the form of standalone hardware, operating system modifications, software or firmware programs, new circuitry, modifications to existing circuitry or any other form as would be understood by the skilled addressee.

Another aspect of the present invention provides a method of synchronising a plurality of USB Host Controllers, comprising:
providing each of said plurality of Host Controllers with a common clock; and
starting the frame counter of each of said plurality of USB Host Controllers at the same time.

Still another aspect of the present invention provides a method of synchronising a plurality of USB Host Controllers, comprising:
providing each of said plurality of Host Controllers with a common clock; and
determining the difference between the, frame counters of each of said plurality of USB Host Controllers; and
providing a compensation factor to the plurality of USB Devices connected to each respective USB Host Controller.

Another aspect of the present invention also provides synchronous high-channel-count USB Host Controller comprising:
a plurality of USB Host Controllers;
a common clock source; and
circuitry for synchronously initiating the frame counters on each of said plurality of USB Host Controllers.

Yet another aspect of the present invention provides a synchronous high-channel-count USB Host Controller comprising:
a plurality of USB Host Controllers;
a common clock source; and
circuitry for determining the phase offset of the frame counters of each of said plurality of USB Host Controllers.

Embodiments of the present invention extends to systems incorporating various apparatus, USB devices, computers and other components as described above. It is to be understood that the various aspects and embodiments of the present invention are designed to be interoperable and can be combined to form different systems. For example, systems may be customised to meet particular end user requirements.

### BRIEF DESCRIPTION OF THE DRAWING

In order that the present invention may be more clearly ascertained, embodiments will now be described, by way of example, with reference to the accompanying drawing, in which:

FIG. 1 is a schematic diagram of an illustrative prior art USB network.

FIG. 2 is a schematic representation of a prior art measurement of signal propagation time through the USB network of FIG. 1.

FIG. 3 is a schematic representation of the measurement of signal propagation time according to an embodiment of the present invention.

FIG. 4 is a schematic representation of the signals involved in synchronising the time of a computer system according to an embodiment of the present invention.

FIG. 5 is tabular representation of the data stored in regard to synchronising a PC with regard to UTC.

FIG. 6 is a graphical representation of the mapping between PC Time and external time (UTC in this case).

FIG. 7 is a schematic representation of a method of synchronising a plurality of computers.

FIG. 8 is a schematic representation of a time trigger device according to an embodiment of the present invention.

FIG. 9 is a schematic representation of the various data packets flowing in a prior art USB.

FIG. 10 is a schematic representation of the data packet flow in a USB according to an embodiment of the present invention.

FIG. 11 is schematic representation of yet another embodiment of minimising trigger latency according to the present invention.

FIG. 12 is a schematic representation of a typical laboratory oscilloscope.

FIG. 13 is a schematic representation of a system for synchronising the timebase of a USB with a typical laboratory oscilloscope.

FIG. 14 is a schematic representation of synchronisation signals being transferred between an Instrument and a USB expansion hub.

FIG. 15 is a schematic representation of the signal flow options for synchronising a USB time domain with that of a measurement instrument.

FIG. 16 is a schematic representation of the measurement data aligned by periodic triggers sent from the time domain of the Oscilloscope.

FIG. 17 is a schematic representation of the measurement data aligned by trigger events sent from the time domain of the USB Device to the Oscilloscope.

FIG. 18 is a schematic representation of an embodiment of synchronising and triggering a USB device.

FIG. 19 is a schematic representation of a synchronised multi-host USB.

### DETAILED DESCIPTION OF THE INVENTION

The above described embodiments can be employed in a variety of ways. The following descriptions are intended to show exemplary embodiments of the present invention, but are not intended to represent the entire scope of application of the present invention. The various embodiments and examples shown here are intended to be combined and the combined functionality is inferred.

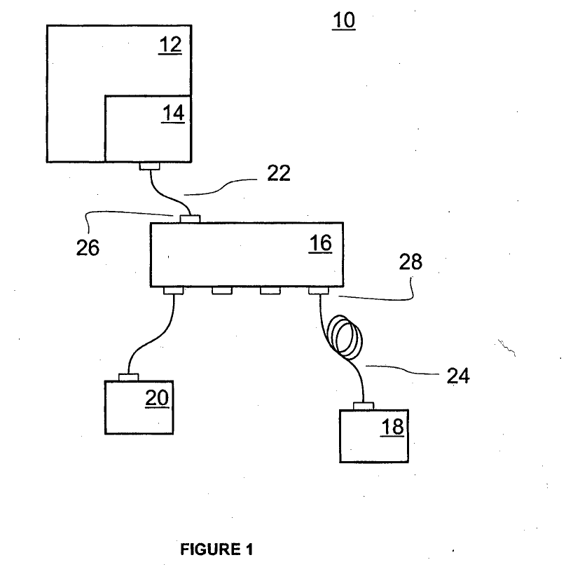

A typical prior art USB is shown schematically at 10 in FIG. 1, wherein Personal Computer (PC) 12 contains a USB Host Controller 14 which is connected to a USB Hub 16 which subsequently connects to a plurality of USB devices 18 and 20. USB cable 22 connects the Host Controller 14 to the USB Hub 16 and USB cable 24 connects the USB Hub 16 to the USB device 18.

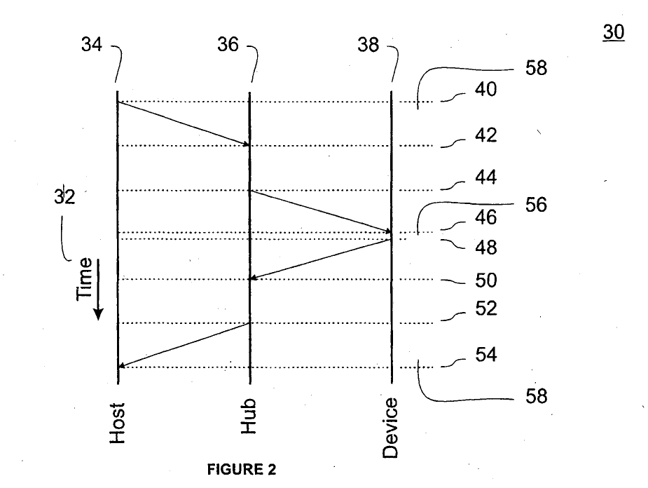

FIG. 2 shows schematically at 30 the time taken for signals to propagate across the USB network of FIG. 1. Passage of time is represented by the vertical ordinate shown by the Time Arrow 32 while the spatial dimension (distance from the Host Controller) is shown by the horizontal ordinate. The position of the Host Controller (14 of FIG. 1) is shown at 34, the position of the USB Hub 16 is shown at 36 and the position of the USB device 18 is shown at 38. For the purpose of this figure there is no distinction between the upstream port 26 and the downstream port 28 of USB Hub 16.

Consider the propagation of a USB time-of-flight measurement packet according to the disclosure of Foster et. al. (U.S. Pat. No. 7,539,793) across the system. A USB packet which can be considered a ‘ping’ message is sent from the Host Controller 34 at time 40. Said ping message propagates across USB cable 22 and arrives at the upstream port 26 of USB hub 16 at time 42. There is some delay in the message passing through the USB Hub 16 and said message is transmitted from the downstream port 28 of USB Hub 16 at time 44 before propagating along USB Cable 24 and arriving at USB Device 18 at time 46.

After a small delay, USB Device 18 transmits a response to the ping message at time 48. In the disclosure of Foster the response was a USB ACK or NAK packet. Said response is received at the downstream port 28 of USB Hub 16 at time 50. After the propagation time through the USB Hub 16, said response is transmitted from the upstream port 26 of USB Hub 16 at time 52 before being received at Host Controller 14 at time 54.

This arrangement however is limited in that the sequence of determining the loop time can only measure times between time 42 and time 52 because the apparatus used to measure said loop time is contained within USB Hub 16, specifically at the upstream port 26 in the disclosure of Foster et. al. More specifically said apparatus comprises a timer that starts at time 42 when said ping message passes through the detection point and stops at time 52 when the response message is detected. As a result of the topology, the propagation time of signals across the USB from Host Controller 14 to USB Device 18 is unknown since propagation time across USB cable 22 (ie time period 58) is outside of the measurement loop.

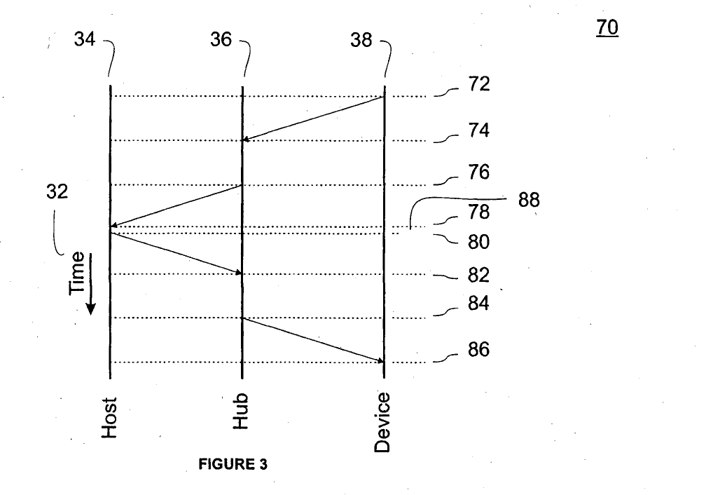

A methodology of determining PC time with respect to USB Device time of the present invention is shown schematically at 70 in FIG. 3. The schematic representation refers to the physical USB of FIG. 1 and identical features retain the numbering from FIG. 2 for simplicity. USB device 18 transmits a message packet at time 72. Since all USB transactions are initiated by the Host Controller, said message packet is merely a response to a specific Host generated request. However said message packet may be considered to be a ‘ping’ message. Said ping propagates upstream across USB cable 24 and arrives at the downstream port 28 of USB Hub 16 at time 74. After passing through the USB Hub 16, said ping is transmitted from USB Hub upstream port 26 at time 76 being received at Host Controller 14 at time 78.

USB Host 14 responds to receipt of said ping message by transmitting a handshake response message at time 80 after a short latency delay. Said response message arrives at the upstream port 26 at time 82, is transmitted from the downstream port 28 at time 84 and is received by USB device at time 86. While the response message used to determine said round trip time may be any packet, a preferable embodiment would employ the USB ACK or NAK packets.

According to the present invention, USB Device 18 contains counter/timer circuitry to measure the time between transmission of said ping message 72 and reception of said response message 86. This is in addition to circuitry for attaching to the USB and circuitry adapted to transmit data packets to the Host Controller 14 across the USB. The circuitry of USB device 18 involved in implementing the first aspect of the present invention may be located with communication endpoint circuitry of the USB device 18.

The circuitry adapted to transmit data packets to the Host Controller 14 may be a conventional USB device circuit, and the message sent may be any message, and may be part of normal operation of the USB device 18. The USB device 18 may thus utilise normal USB traffic in order to measure a round trip time of USB transactions.

Alternatively, the circuitry adapted to transmit data packets from the USB device 18 to the Host Controller 14 may be configured to intentionally corrupt an otherwise normal data packet. This circuitry may monitor USB transactions between the USB Host Controller 14 and the USB device 18 and may clamp signal levels on the USB during transmission of certain packets in order to intentionally corrupt an otherwise normal data packet.

The propagation time from USB Device 18 to Host Controller 14 is determined to be half of the loop time by symmetry. The propagation delay of signals across the USB from Host Controller 14 to USB device is then known, albeit with a small uncertainty given by half of the latency 88 in the response time of USB Host Controller 14. To improve the accuracy of the measurement, the circuitry and counter/timer circuitry in USB device 18 may be configured to repeatedly measure a round trip time and apply a statistical analysis to the measurements.

Knowledge of the time taken for signals to propagate between the two nodes allows the time of the Host Controller 14 to be synchronised to the time of the USB Device 18. The USB device 18 may include circuitry to transmit the measurement of round trip time to the Host Controller 14 on request of the Host Controller 14.

Alternatively, the propagation time may also be used to synchronise the USB device 18 to the Host Controller 14, or to synchronise multiple USB devices together. If multiple USB devices 18 are connected to the same USB Host Controller 14, each USB device may have a local clock and synchronisation circuitry for tuning the local clock. Examples of circuitry that may be used are given in Foster et. al. (U.S. Pat. No. 7,539,793). Each USB device 18 may first syntonise its local clock to the Host Controller clock, for example by locking its local clock to a Start of Frame (SOF) packet or Isochronous Timestamp Packet (ITP) in a USB data stream from the Host Controller 14 to the respective USB device 18. Each USB device 18 may then determine a propagation time over a cable connecting the USB device 18 to the Host Controller 14, using the method described with reference to FIG. 3. Each USB device 18 may apply a phase offset to its local clock to compensate for the propagation time of signals from the USB Host Controller 14 to the respective USB device 18. In this way, the USB devices 18 may be all synchronised to the USB Host Controller 14 and thus to each other.

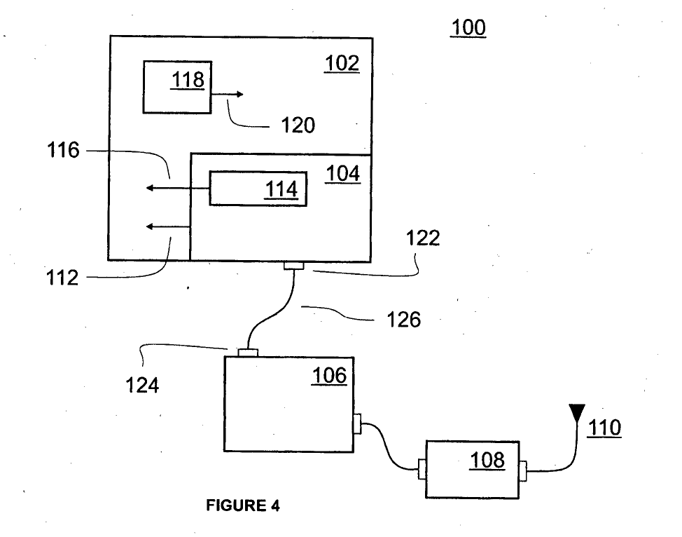

FIG. 4 is a schematic representation shown at 100 of the synchronisation of a computer system according to the present invention. For simplicity the generic computer system will be referred to as a Personal Computer (PC) but this is intended to represent a general computing device, be it a personal computer, mainframe, mobile computing device, smartphone or other computing device.

Personal Computer 102 comprises a USB Host Controller 104 to which is attached a USB comprising at least USB device 106. USB Device 106 is connected to a GPS Receiver/Time-Server 108 to which is attached a GPS antenna 110. Said GPS Receiver 108 may be either contained within said USB Device 106 or may be attached to said USB Device 106 via a communication interface.

GPS Receiver 108 detects GPS signals from GPS satellites via Antenna 110 and provides information about the absolute GPS time. Typically this is in the form of a plurality of information signals, including a 1 Pulse Per Second (PPS) signal that is synchronous with the GPS time second boundary and a timestamp information signal that provides the GPS time of the associated PPS signal. In this way, the GPS Receiver 108 provides knowledge of the current GPS time when satellites are visible, where the accuracy of GPS time is determined by the number of satellites present and the quality of the signals received.

USB Host Controller 104 coordinates all communication across the USB. This includes transmission of Start of Frame (SOF) packets every 1 ms and microframe SOF packets every 125 us (for High Speed USB). USB Host Controller 104 can typically be configured to issue an Interrupt 112 to the system controller at transmission of every SOF packet. Sometimes the Host Controller 104 delays the transmission of Interrupt 112 because it is busy performing some other function. This delay is very small but measureable. Some Host Controllers incorporate a Timer 114 that determines the time delay or interrupt latency between transmission of each SOF packet and generation of its associated Interrupt 112. Interrupt Latency Signal 116 is transmitted by the Host Controller 104 when it issues each Interrupt 112.

Personal Computer 102 contains a Clock 118 which provides a Notion of Time 120. Notion of Time 120 is typically a very large number (for example 64 bits) which counts the time from a certain date/time. One example of such a Notion of Time is Unix Time or POSIX Time. This measures time with respect to the Unix Epoch 00:00:00 UTC on Jan. 1, 1970. In the case of Unix Time the number 1618033988 is a binary representation of 02:53:08 UTC on Oct. 4, 2021.

Another Notion of Time is a counter that measures time monotonically in ticks from a given epoch. In some cases this may be from when the computer was turned on or in other cases may be when the clock counter was reset. The frequency of said Ticks can typically be determined by querying the computer. Since the period of time between successive SOF packets is shorter than the order of 1 ms, the long term drift in the clock frequency is not as important as knowing the current average tick frequency for the latest period.

Modern computer systems operate with a notion of time that can be resolved down to 1 microsecond or better. This Notion of Time 120 is to be differentiated from the Central Processing Unit (CPU) clock which is typically throttled to provide more performance in bursts as required, thus rendering it unsuitable for use as a unit of time.

The present invention discloses a method of mapping between the various time domains present in order to provide applications running the Personal Computer 102 with an accurate knowledge of real time to some external reference standard such as GPS time or UTC. This occurs in several steps.

Firstly, GPS Receiver 108 maintains a local clock synchronised to UTC, GPS time (or some other significant external timebase) that is accurate to the order of a few tens of nanoseconds (at current technological tolerances which will likely be tightened in future). Reception of SOF packets in the USB Device 106 are timestamped with the GPS Time (a first timestamp). Each of these timestamps are transmitted to Host Controller 104.

Secondly, Personal Computer 102 receives Interrupt 112 at the moment each SOF is transmitted from Host Controller 104. Interrupt 112 executes an Interrupt Service Request which causes a timestamp (a second timestamp) to be generated in the Notion of Time 120 of System Clock 118.

Furthermore according to first aspect of the present invention, USB Device 106 is able to determine the propagation time of signals from the Host Controller 104 to itself. This allows Personal Computer 102 to map the two different time domains together—SOF Generation Time (Host Controller 104) and SOF Reception Time (USB Device 106). Typically this would be done by mapping to the domain of SOF Generation Time (but it would be equally valid to map to SOF Reception Time). It must be noted that one need not employ the propagation time measurement as disclosed in the present invention. This merely improves the accuracy of the determination of PC time.

Observing FIG. 4, a given SOF packet is generated by Host Controller 104 at 122 at a Generation Time. Said SOF packet is received by USB Device at 124 at a Reception Time. Since the Transmission Time of an SOF packet along Cable 126 is measurable according to the first aspect of the present invention, it is possible to map between Generation Time and Reception Time by addition or subtraction of the said fixed Transmission Time.

SOF Reception Time is delayed with respect to SOF Generation Time by the Propagation Time. Therefore in order to determine the absolute time (UTC for example) of the generation of a specific SOF Number, one would determine the UTC timestamp of Reception of said specific SOF Number by USB Device and subtract the Transmission Time. This is the logical mapping as the main aim is to ensure we synchronise the time inside the PC to an external reference timebase.

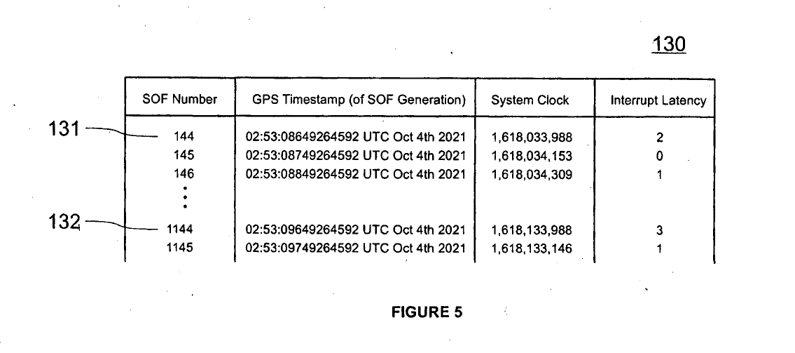

Personal Computer 102 then builds a Synchronisation Table of timestamps against SOF number. FIG. 5 represents a typical Synchronisation Table shown at 130. In the exemplary table at 130 the GPS Timestamp has been mapped to the generation time of said respective SOF. As stated, this is just a constant phase offset from the timestamped SOF Reception at 124. Table 130 also contains a recording of the Clock Time 120 at the SOF Generation Time. There will obviously be some small error in the system time measurement because of the somewhat uncertain time it takes for the interrupt service routine to act on the SOF Interrupt 112. Some systems include the Timer 114 which can also provide the latency in issuing the Interrupt 112 and this would then be included in table 130.

Table 130 may be held in a circular buffer in memory with only the latest timestamps being retained for calculation purposes or the data may be retained indefinitely. Table 130 contains all of the information to determine the absolute time. This process would most likely occur in a Kernel Driver in order to maintain optimum performance, but may also operate in User Space.

Consider row 131 of table 130. The numbers in this table are merely indicative. This shows SOF number 144, the generation of which has been timestamped as UTC 2:53 am (plus a fraction of a minute) on Oct. 4, 2021. The row also shows that the Clock read 1,618,033,988 at SOF Generation and there was 2 microseconds delay in generating the Clock Request. It would also be possible to incorporate the Interrupt Latency measurement directly into the Clock time. One second later, the SOF number would be 1144 at row 132. The final component of the system is an Application Programming Interface (API). This provides the external interface that allows other applications to access the absolute time.

Let us consider how one would query the system to find the actual Current Time. Firstly the user would call an API function that returns the computer's notion of time, Time A. Then the user would call an API function that returns the most recent row of table 130. This would provide two times of interest, UTC Time and the computer's notion of time at the UTC timestamp, Time B—both corresponding to the most recent SOF. The user would then determine the difference between system times Time A and Time B—how long in the computer's notion of Time since the most recent UTC Timestamp. This difference (measured in System Time Ticks) would then be added to the UTC time corresponding to Time B. The average period of a Tick (the smallest unit of the computer's notion of time) may be determined by calculating the evolution of UTC in Ticks over recent cycles or by utilising some other API function that returns information about the Tick frequency.

The average period of a Tick may be calculated during the API call that returns current time, but this would increase the latency in returning the system time at the moment, of said API call. Preferably, the average period of a System Time Tick would be calculated during the process that updates the Table 130—namely during the Interrupt Service Routine that is called by Interrupt 112. Furthermore in a preferable embodiment, statistical techniques may be applied to the evolution of time such that the period of Ticks is modelled and a predictive tuning system (such as but not limited to Kalman filtering) used to more accurately determine the current period of a Tick.

This method may preferably be performed internally within the Driver with one call performing all of the steps above and simply returning the Current Time.

It is also possible for the user to request that the API notify them when the current time is a required Alarm Time. In this case the user would set the Alarm Time and wait for an interrupt or possibly a callback function at the Alarm Time. In this scenario, the system would extrapolate the evolution of System Time (the rate of System Time Ticks) from the new rows of table 130 acquired at each SOF. It is then possible to determine the future System Time corresponding to the UTC Alarm Time.

The present'invention therefore provides a means of synchronising the time of a plurality of Computers, each of which employs the methods disclosed in the present invention. In this way a plurality of computers located anywhere on the planet may be synchronised to a common time and said computers timestamp events or simulations to an arbitrary degree. USB Connection 126 may be a non-SuperSpeed connection, a SuperSpeed connection or maintain connection of both busses simultaneously. In the latter case said SuperSpeed connection would preferably contain the data delivery (communication) channel while the non-SuperSpeed connection would contain synchronisation and trigger information to both maximise the communication bandwidth and minimise the triggering latency.

It is important to note here that this approach may be applied to any Personal Computer bus system. The description above describes a USB implementation but the present invention is equally applicable to other interface busses whereby the system controller is able to timestamp packets in both the bus Host Controller and attached Device, preferably with the ability to determine signal transmission time across the interconnect, for example but not limited to PCI, PClexpress, VME, SATA, DisplayPort, LightPeak, Thunderbolt, to name a few.

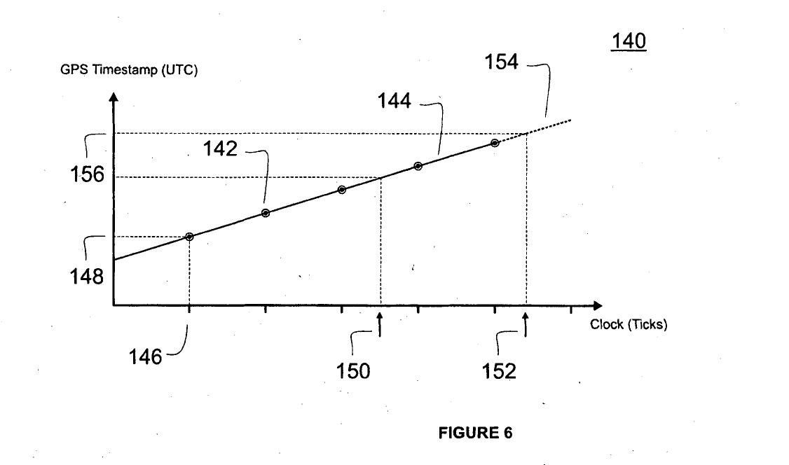

This is shown graphically in FIG. 6 at 140. This is a plot of the evolution of time in the two time domains. The horizontal axis represents the notion of time of the computer Clock 118 of FIG. 4 which is measured in units of Ticks, where one tick is the period of one clock cycle. Preferably a clock is chosen such that it is monotonically, increasing with a constant frequency. The vertical axis represents the external time domain, GPS-derived UTC in this case. Dots on the graph 142 represent the time that the two domains are mapped together, in this case by detection of a plurality of SOF patterns in each of the respective time domains, while the line 144 represents a line of best fit to the data points 142. If the evolution of time in both domains are stable then there is a linear relationship.

The moment in the time domain of the PC Clock 118 that an SOF pattern is generated by the Host is shown at 146. There is a corresponding moment in the time domain of the GPS clock that the same SOF pattern is detected by the USB Device 148 (allowing also for any compensation for SOF Interrupt latency or signal propagation time). In this way the tick counter value of the PC Clock is mapped to a precise GPS time at each of said plurality of data points 142, providing a mathematical relationship, linear in the case presented here but it need not be, between the two time domains.

Now take the case where a process on the PC needs to know the exact current time at say 150. At this point, only data points to the left of 150 have been recorded. The system may wait until the following data point has been captured and then report a linear interpolation. In another case, where the PC needs to know the exact timestamp at 152, the system may extrapolate 154 from the current data 144 to determine the timestamp and return the value immediately.

Furthermore if the user were to need an event to occur at a given time 156 then the relationship 144 could be extrapolated to determine the time 152 in the PC clock domain, which may subsequently be used to trigger an interrupt or other event.

It will be appreciated that the mapping between two different notions of time may be stored in USB device 106 rather than in PC 102. In this embodiment, the PC 102 may transmit its timestamps and associated SOF packet frame numbers to the USB device 106, together with any interrupt latency values.

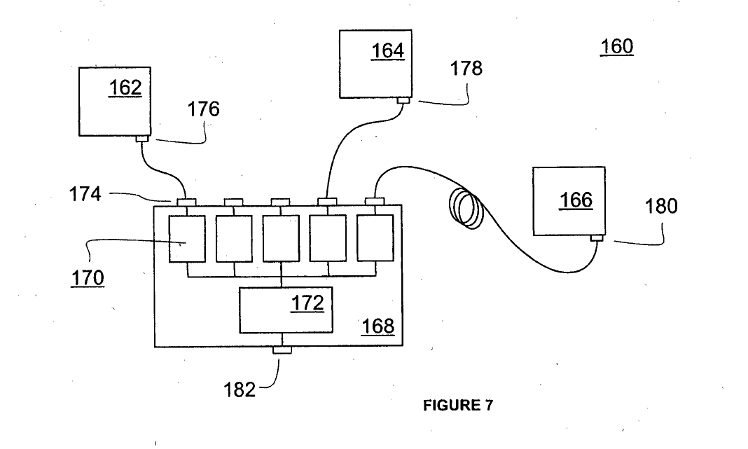

A plurality of computers may be synchronised to a common time according to the present invention as shown in FIG. 7 at 160. A plurality of computers 162, 164, 166 are attached to a common Apparatus 168 via USB. Apparatus 168 contains a plurality of USB Devices 170 and a Clock 172. The Host

Controller of each of said plurality of Computers 162, 164, 166 is connected to one of said plurality of USB Devices 170 contained within Apparatus 168 via the respective upstream port 174 of said plurality of USB Devices 170. This may be through either a direct connection to their respective root hub ports 176, 178, 180 as shown at 160 for simplicity or via a chain of USB cables and USB hubs.

Clock 172 maintains a notion of time. This time may be simply related to counting the ticks of an internal oscillator with a nominal tick period, said tick period may either be of known duration or of unknown but typically stable and consistent duration. The notion of time may also be related to the period of a known reference oscillator. Additionally still, said Clock may be synchronised to an external reference source of time.

In an embodiment, the clock 172 may also contain FPGA circuitry, which may be used to perform calculations on data obtained by each of the USB Devices 170.

According to the first aspect of the present invention SOF packets generated by Computer 162 and timestainped with respect to the Clock of Computer 162 are transmitted to one of said plurality of USB Devices 170. Respective USB Device 170 timestamps reception of said SOF packet with respect to the local Clock 172. As disclosed the loop propagation time from the Host Controller port 176 to the respective upstream port 174 of USB Device 170 can be determined and hence propagation time of SOF packets from Host Controller to USB Device inferred. This allows the Time of the Computer 162 to be determined with regard to Clock 172. A similar method can be applied to determine the Time at each of said plurality of Computers 164 and 166. The resulting plurality of synchronised computers utilise only the simple USB bus for connection and synchronisation.

Apparatus 168 may additionally have an External Clock Port 182 for connection of an external time source, such as but not limited to a GPS Clock, an IEEE-1588 Clock, an IRIG time code generator, an NTP'source, etc. In this case said Timestamp provided to each of said computers would be an absolute reference time instead of an arbitrary but monotonically increasing time. Furthermore an absolute time reference may be included within Clock 172.

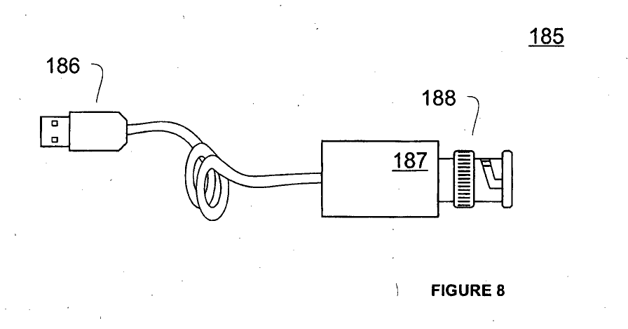

A time Trigger Device is shown in FIG. 8 at 185. This device 185 may be used to perform synchronous triggering of external equipment. The device is attached to a USB via USB connector 186. It contains circuitry 187 and an Input/Output (I/O) Connector 188 for connection to external equipment. Preferably Circuitry 187 synchronises to the timebase of the Host Controller by any of the methods of the present invention or those taught by Foster et. al (U.S. Pat. No. 7,539,793 and U.S. patent application Ser. No. 10/620,769), and Foster (International Patent Application No PCT/2007/000155). Preferably also said Circuitry is able to determine the propagation time of signals across the USB from said Host Controller. Preferably this is by means of the first broad aspect of the present or any other appropriate means. This allows phase-accurate synchronisation of the time of each of a plurality of such Trigger Devices 185, said plurality of devices then being able to operate in a time-coordinated manner. Said plurality of Trigger Devices could then operate to each output a signal from their respective I/O Connector 188 with precisely aligned phase.

Furthermore the present invention provides a mapping between the time domain of the Host Controller and the clock of the personal computer itself. As disclosed in the second broad aspect of the present invention, a process operating on the Computer may be checking the Tick counter periodically and determine that a trigger event is required at a certain future Tick time. The system would then determine what USB (or SOF) time corresponds to said future Tick time, deliver said corresponding

USB Time to Trigger Device 185 and what action said Trigger Device 185 should take at said USB Time. Using a plurality of said Trigger Devices would allow a plurality of phase accurate trigger events to be executed. Knowledge of the propagation time of signals across the USB allows accurate phase alignment of the edge transitions across said plurality of Trigger Devices 185.

In this way the computer can generate a trigger event at the I/O Connector 188 at a predetermined time—either USB time or the Computer's Tick time. For example, the Computer may be performing a simulation and need to trigger another computer or external equipment to do something at a specific time with regard to the simulation's notion of time. Note that simulation is but one example of a process that may require an external trigger to be generated with regard to the notion of time of a process running on a computer.

Similarly said Trigger Device 185 can timestamp external events with regard to the local USB time (and subsequently deliver this information to a system controller or other attached USB devices) or the Computer's Tick time.

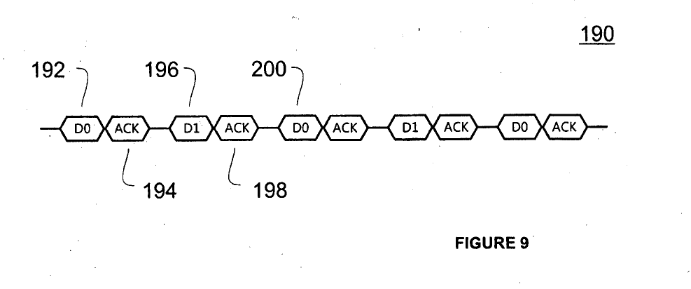

FIG. 9 is a schematic representation of the flow of data packets in a prior art USB, such as the one shown in FIG. 1 at 10, the numbering of which will be used for this discussion. Host Controller 14 of computer 12 communicates to each attached plurality of USB Devices 18 and 20 in a broadcast fashion. Headers in each data packet sent from said Host Controller 14 inform each of said plurality of USB Devices 18, 20 which Device and Endpoint the data is destined for. FIG. 9 shows only packets destined for a specific one of the sixteen possible endpoints of a single USB Device, say device 18. All other data packets that are destined for another endpoint or another device altogether have been removed from this figure to show only communication to a specific endpoint.

The headers of each data packet also indicate the type of data packet. This may be, for example, SOF, PING, Data0 or Data1. As a check on the integrity of the data, the Data0 and Data1 packet headers alternate, so that a device can determine that a packet directed to it has been lost, or has arrived out of order.

A Data0 packet 192 is transmitted from the Host Controller 14 to USB Device 18. Only the packet ID (D0) is shown for simplicity. The USB Device 18 transmits upstream an acknowledge handshake packet ACK 194. This informs the host that the packet has been successfully received intact and that the transaction is complete from the perspective of the USB Device 18. The next data packet sent from the Host Controller 14 to the USB Device 18 is a Data1 packet 196. Data packets alternate between Data0 and Data1 state. This is followed again by an ACK packet 198. The next packet to be sent is a Data0 packet 200 and so on.

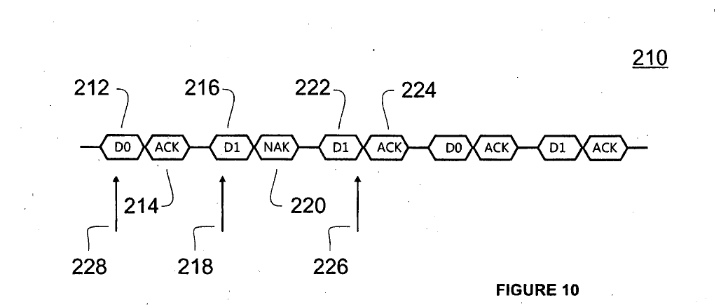

FIG. 10 is a schematic representation of the flow of data packets in a USB according to the present invention at 210. Again reference will be made to the numbering of FIG. 1 at 10. In this case USB Device 18 has been designated the trigger device and USB Device 20 the slave device which must perform some action on reception of a trigger signal from USB Device 18. USB Device 18 must send a trigger signal to USB Device 20 as quickly as possible, with minimal latency.

USB Host Controller 14 schedules a periodic communication packet to be sent to a specific Endpoint in USB Device 18. USB Host Controller 14 also informs USB Device 20 that the Trigger Signal will be contained in the communication channel between said Host Controller 14 and said specific Endpoint in USB Device 18.

USB Device 20 then begins to decode the USB data stream received at its upstream connection not only for communication that is intended for it (where the Packet Header contains the enumerated USB address of USB Device 20) but decodes all communication received from the host. Specifically USB Device 20 is searching for communication packets that are designated to be delivered specifically to said specified Endpoint of USB Device 18. Trigger signals for USB Device 20 will therefore be encoded within data specifically designated for said specific Endpoint of USB Device 18. USB Host Controller 14 begins to send said periodic communication packets to said specific Endpoint of USB Device 18. The data packets initially follow the same format as shown in FIG. 9, namely with an alternating Data0/Data1 packet ID for each successive packet. Now moving to FIG. 10, USB Host transmits data packet Data0 212 to USB Device 18 (which is also observed by USB Device 20) to which USB Device 18 replies with an ACK packet 214. This is the natural sequence as per the end of FIG. 9 and ACK 214 ends the transaction. The next data packet sent to said specified Endpoint on USB Device 18 is a Data1 packet 216.

Now at some point in time 218 a Trigger Event occurs in USB Device 18. Said Trigger Event may be as a result of a certain function of Device 18 or may be in response to USB Device 18 receiving a signal from an external source. Said Trigger Event at time 218 occurs at some point before USB Device 18 has responded to reception of the Data1 packet 216. Said Trigger Event at time 218 can be any time from the ACK packet 214 until USB Device 18 completes transmission of its response 220 to data packet Data1. Given that said Trigger Event has occurred, USB Device 18 must issue a signal to USB Device 20, therefore USB Device 18 alters the normal ACK response to data packet Data1 216 and instead transmits a response that indicates the packet delivery has failed at packet 220. This may be achieved in any number of ways such as actually transmitting a NAK packet token (as shown at 220), transmitting an erroneous packet response such as with a corrupt CRC (checksum) field or merely not transmitting any response at all. All that is required is that USB Host Controller 14 thinks that the transaction, corresponding to packet 216 and its associated handshake 220, has failed.

This prompts the USB Host Controller to repeat the supposedly failed transaction. Hence packet Data1 216 is retransmitted by the Host Controller 14 as packet Data1 222, which would naturally be followed by a handshake response ACK 224 from USB Device 18. This handshake sequence (NAK 220) between USB Host Controller 14 and USB Device 18 changes the natural alternating Data0/Data1 sequence. Data1 has been repeated. It may be either Data0 or Data1 that is repeated, depending on when said Trigger Event at time 218 occurs. For example, if said Trigger Event 218 had occurred one transaction earlier at Time 228 then it would have been data packet Data0 212 that was repeated. All that matters is that there is a repeat in the data packet sequence.

All the while USB Device 20 is observing the USB for transactions addressed to said specific Endpoint in USB Device 18. In this way when USB Device 20 decodes a repeated Data1 or Data0 token it can assume that this is a Trigger Signal from USB Device 18. Now it is possible that there are occasionally corrupt transactions in USB, hence the reason for the handshaking. Therefore it is preferably for USB Device to intentionally corrupt a plurality of sequential transaction handshake packets this indicating to USB Device 20 that said Trigger Event has occurred in USB Device 18, with higher probability than just a single corrupt transaction.

This method may be applied to a plurality of USB Devices (similar to 20) resulting in a trigger signal being sent from USB Device to each of said plurality of other USB Devices (similar to 20).

There are a multitude of other packet manipulations that may be made in order to prompt the error correction mechanisms of USB to repeat a transaction in order to inform a plurality of USB Devices of the occurrence of a Trigger Event on another attached USB Device. The manipulation of the ACK handshake packet explicitly disclosed is but one means of achieving this aim and each of these alternate packet manipulations are within the scope of the present invention. One further means involves using the PING transaction.

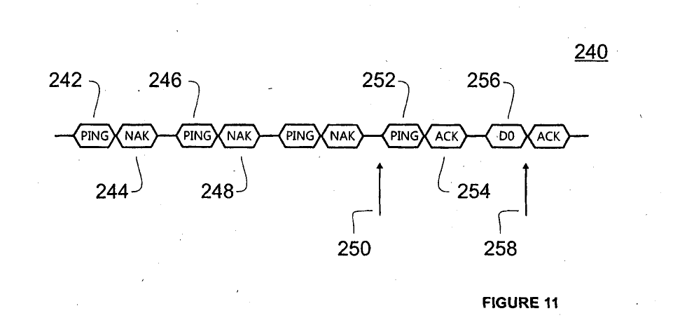

According to another embodiment of the present invention the latency of a trigger signal being sent from one USB Device to a plurality of other attached USB Devices is minimised. The data flow utilised for this embodiment is shown in FIG. 11 at 240. Yet again reference will be made to the numbering of FIG. 1 at 10. In this case USB Device 18 has been designated the trigger device and USB Device 20 the slave device which must perform some action on reception of a trigger signal from USB Device 18. USB Device 18 must send a trigger signal to USB Device 20 as quickly as possible, with minimal latency.

USB Host Controller 14 schedules a periodic communication packet to be sent to a specific Endpoint in USB Device 18. USB Host Controller 14 also informs USB Device 20 that the Trigger Signal will be contained in the communication channel between said Host Controller 14 and said specific Endpoint in USB Device 18.

USB Device 20 then begins to decode the USB data stream received at its upstream connection not only for communication that is intended for it (where the Packet Header contains the enumerated USB address of USB Device 20) but decodes all communication received from the host. Specifically USB Device 20 is searching for communication packets that are designated to be delivered specifically to said specified Endpoint of USB Device 18. Trigger signals for USB Device 20 will therefore be encoded within data specifically designated for said specific Endpoint of USB Device 18.

USB Host Controller 14 sends a PING packet 242 to said specific Endpoint of USB Device 18 (which is also observed by USB Device 20). USB Device 18 replies with a NAK packet 244. This indicates that a Trigger Event has not yet occurred. The USB Host Controller 14 follows up with another PING message 246 followed by a NAK 248 from USB Device 18. This pattern continues until at Time 250 the Trigger Event occurs in USB Device 18. This is the trigger for USB Device 18 to stop sending NAK responses. USB Host Controller sends its next PING 252 which is replied to by USB Device 18 with an ACK 254. This tells the Host Controller 14 that said specified Endpoint of USB Device 18 is ready to receive data packets. USB Host Controller then sends its data packet 256 to said specified Endpoint of USB Device 18. Now as discussed USB messages are broadcast so Data packet 256 is received by all other USB Devices. USB Device 20 decodes Data Packet 256 and determines that said packet 256 is indeed addressed to said specific Endpoint of USB Device 18. This provides confirmation of the Trigger Signal at 258.

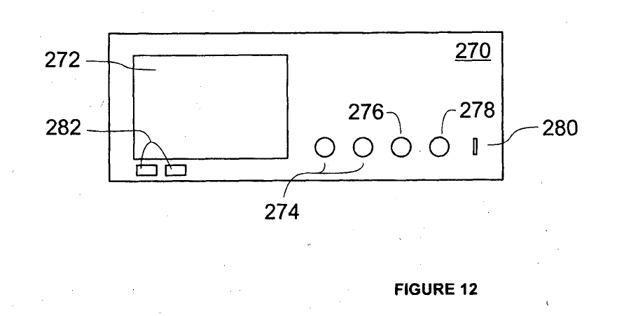

A schematic representation of a typical laboratory Oscilloscope is shown in FIG. 12 at 270. Oscilloscope 270 has a graphical Display 272, a plurality of Signal Inputs 274, a Trigger Port 278 (input and/or output), Clock Port 276 (input and/or output) and a Probe Compensation Output 280. Most such instruments also include a plurality of USB Ports 282 for connection of keyboards, mice and other peripherals. Most oscilloscopes include a Probe Compensation Output 280, but many do not include a Clock Port 276.

Said plurality of Signal Inputs measure the signals and display the measurements on Display 272 in both graphical and numerical form. A Trigger Port 278 is typically configured as an input which is configured to initiate a measurement cycle when a certain stimulus is applied. This may alternatively be configured to provide a trigger output signal. Clock Port 276 is typically configured as an input to allow a more precise clock signal to act as the timebase of the instrument. This may alternatively by configured as an output to deliver the clock source of the instrument to an external device. Probe Compensation. Output 280 is used to provide a signal, typically a square wave at approximately 1 kHz frequency, for calibration of the signal probes attached to said plurality of Signal Inputs 274.

The Oscilloscope of FIG. 12 is representative of a typical laboratory instrument that may have signal inputs to measure a signal, a Trigger Port, a Clock and Probe Compensation Port. Other examples include Spectrum Analysers, Network Analysers, RF Meters, and the list goes on.

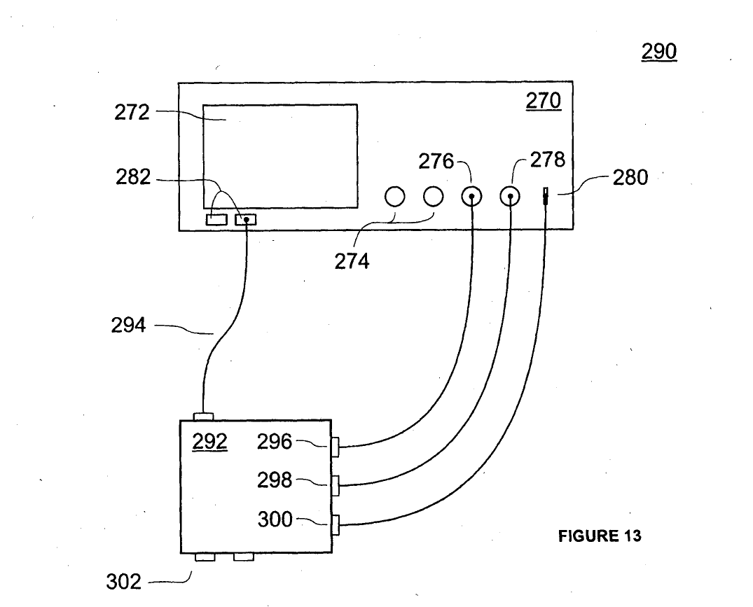

FIG. 13 shows a schematic representation of an embodiment of synchronising a USB Device with the typical laboratory Oscilloscope 270 of FIG. 12. Similar numbering has been maintained from FIG. 12 for simplicity. USB Device 292 is attached to one of said USB Ports 282 of Oscilloscope 270 via USB Cable 294.

USB Device 292 has a Clock Output Port 296, a Trigger Port 298 (which can be configured for bidirectional signal flow) and a Clock Input Port 300.

Said USB Device 292 is preferably a measurement or signal generation device. In this case Port 302 represents the Signal Input port (or alternatively a Signal Output port) of USB Device 292, analogous to the Signal Input 274 of Oscilloscope 270. Data gathered via Signal Input port 302 may be transmitted to the Oscilloscope 270 via USB cable 294. Synchronisation of the timebase of the Oscilloscope 270 and USB Device 292 allows the various signals present at 274 and 302 to be correlated and displayed together.

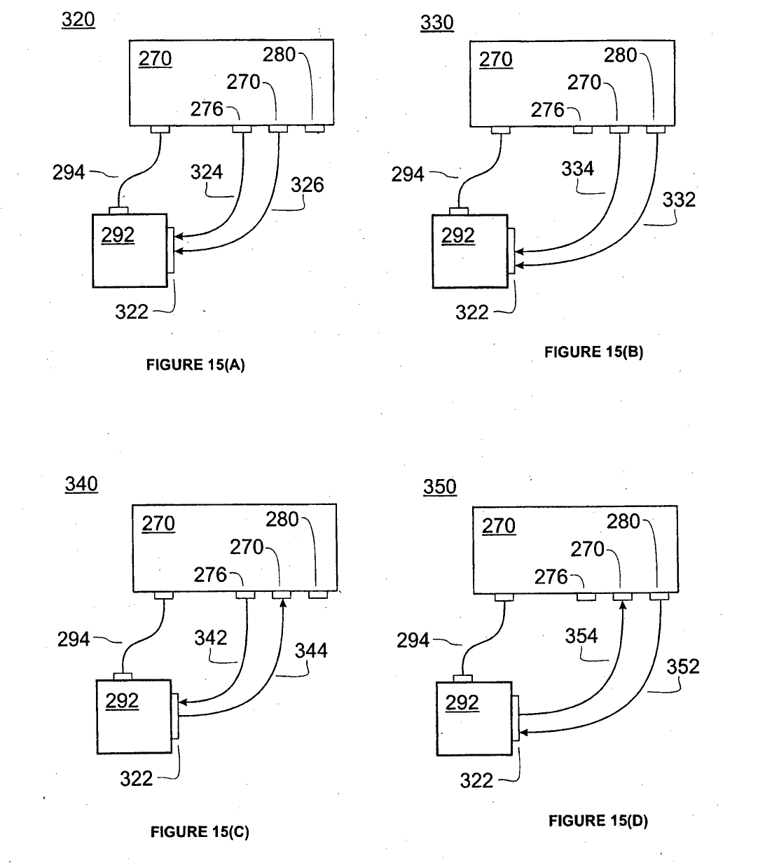

A local clock at the USB device 292 may be synchronised to a clock of the Oscilloscope 270 using a connection to the Probe Compensation Output 280 or Clock Port 276, as will be described with reference to FIG. 15.

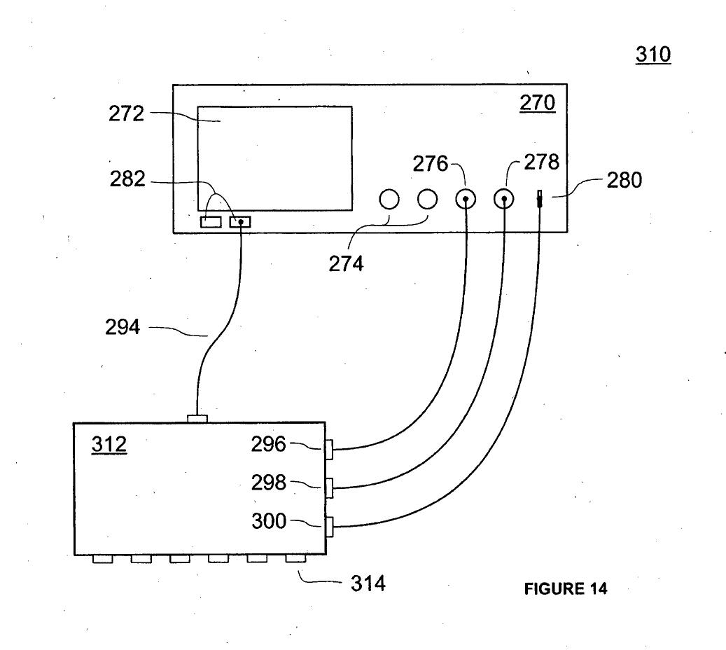

In yet another embodiment of the present invention shown at 310 in FIG. 14, a USB Hub 312 is connected to the USB Port 282 of Oscilloscope 270, where the numbering has been maintained from FIGS. 12 and 13 for simplicity. In this case a plurality of downstream USB Ports 314 provide expansion of the USB for connection of other USB Devices. Clock Output port 296, Trigger In/Out Port 298 and Clock Input Port 300 provide functionality as per FIG. 13 for synchronisation of the two timebases.

Alternatively the USB Device may be a composite device containing USB Hub functionality and USB measurement (or signal generation) functionality. In any of these cases however ports 296, 298, 300 are present to allow synchronisation of the respective timebases of the Oscilloscope 270 and USB (delivered across USB Cable 294).

In yet another preferred embodiment the functionality of Device 292 is combined within said Oscilloscope 270 such that the timebase of the oscilloscope is synchronised to the USB without external connections.

FIG. 15 is a schematic representation of the flow of clock and trigger signals in the synchronisation methods of FIG. 13, where like numbers have been retained for simplicity. Port 322 combines the features of ports 296, 298, 300 of FIG. 13 as a means of simplifying FIG. 15.

FIG. 15(A) at 320 shows the Oscilloscope 270 driving both Clock 324 and Trigger 326 signals to synchronise the attached USB Device. FIG. 15(B) at 330 shows the Oscilloscope 270 driving the Clock 332 (via the probe compensation port 280 of Oscilloscope 270) and Trigger 334 signals to synchronise the attached USB Device. FIG. 15(C) at 340 shows the Oscilloscope 270 driving Clock 342 signals to but receiving Trigger 344 signals from the attached USB Device. FIG. 15(D) at 350 shows the Oscilloscope 270 driving Clock 352 signals (via the probe compensation port 280 of Oscilloscope 270) to but receiving Trigger 354 signals from the attached USB Device.

In each case, a local clock of the USB device 292 is synchronised to a clock signal, transmitted via either the probe compensation port 280 or the clock port 276. The local clock of the USB device 292 may be phase compensated to take into account a propagation time for the clock signal to transmit to the USB device 292 from the Oscilloscope 270.

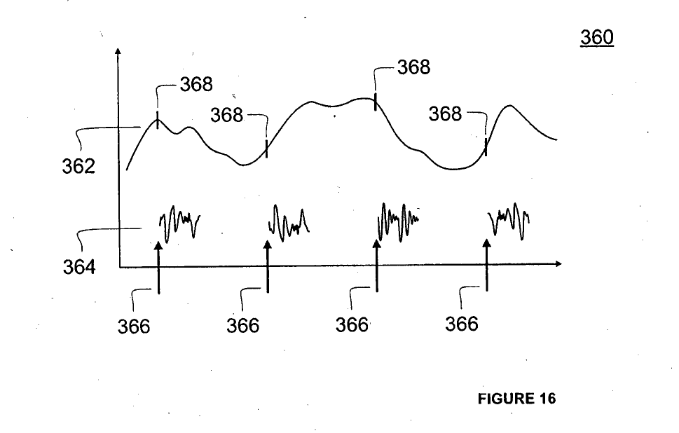

FIG. 16 is a schematic representation of the data at 360 that has been acquired by two measurement instruments, an Oscilloscope 270 and USB Device 292 connected together as shown in either FIG. 15(A) or 15(B). In both of these cases, both Clock 324, 332 and Trigger 326, 334 signals are sent from the Oscilloscope 270 to the USB Device 292.

Typically the Oscilloscope would have higher measurement sampling frequency than the USB Device although this is not necessarily the case. In the case discussed here by way of example, the USB Device is a sensor measurement device capable of continuously measuring and streaming data back to the Oscilloscope via USB Cable 294. The Oscilloscope on the other hand is capable of measuring very high speed signals but in bursts (with dead time gaps in between).

Trace 362 represents data from the, continuously sampling USB Sensor Device while trace 364 represents data acquired in bursts by the Oscilloscope 270. Triggers are sent from said Oscilloscope 270 to said USB Device 292. In this case triggers in the Oscilloscope are most important. The

Oscilloscope 270 may be triggering repeatedly 366 off the analog signal or alternatively auto-triggering on an internal timer reaching terminal count. Each of said plurality of triggers 366 are sent to said USB Device, the reception of which are timestamped in the USB time domain. A record of the time of triggering in the Oscilloscope time domain is also kept. Subsequently the data acquired by said USB Device 292 is marked with a plurality of Timestamps 368 corresponding to each respective one of said Oscilloscope triggers 366, regardless of what those trigger events happened to be.

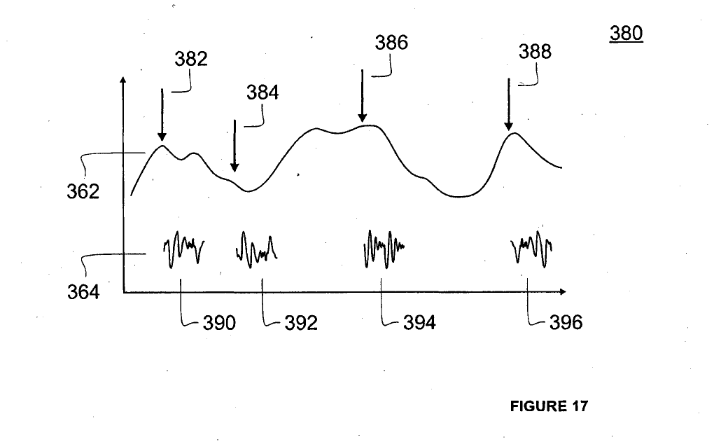

FIG. 17 on the other hand is a schematic representation of the data at 380 that has been acquired by two measurement instruments, an Oscilloscope 270 and USB Device 292 connected together as shown in either FIG. 15(C) or 15(D). In both of these cases, the Clock signals 342, 352 are sent from the

Oscilloscope 270 to the USB Device 292 while the Trigger signals 344, 354 are sent from USB Device 292 to Oscilloscope 270.

Trace 362 represents data from the continuously sampling USB Sensor Device while trace 364 represents data acquired in bursts by the Oscilloscope 270. Triggers are sent from said USB Device 292 to said Oscilloscope 270. In this case, each of the plurality of Triggers 382, 384, 386, 388, originate in the USB Time Domain 292, either from within said USB Device 292 (possibly based on an analog threshold in the measured signal) or from a timestamped trigger event occurring within any attached USB Device (only one device 292 shown in FIG. 15 for simplicity). The Triggers 382, 384, 386, 388 cause the Oscilliscope 270 to measure a high speed signal for a burst of time, as shown at 390, 392, 394, 396 respectively. The Oscilloscope 270 records the time of measuring the bursts of data in the time domain of the Oscilloscope 270.

It would be readily apparent to those skilled in the art that clock and trigger signals 324 and 326 respectively in FIG. 15(A) may be sent between Oscilloscope clock circuitry and USB circuitry entirely within the Oscilloscope 270 as opposed to externally sent (because the Oscilloscope contains the USB Host Controller to which these synchronised USB Devices are attached).

The data traces 362 and 364 of FIG. 16 or of FIG. 17 may be correlated together, and events occurring at the same time may be aligned horizontally when displaying the data traces 362 and 364.

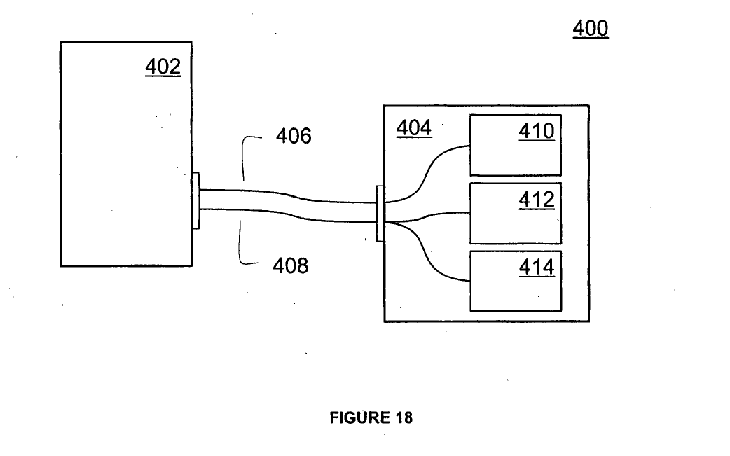

The various embodiments disclosed in the present invention are ideally combined in the preferred embodiment shown schematically in FIG. 18 at 400. USB Host Controller 402 is connected to USB Device 404 via both a SuperSpeed channel 406 and a non-SuperSpeed channel 408.

SuperSpeed channel 406 connects to a SuperSpeed Function 410 which provides the main data link or communication channel between Host 402 and the functionality of USB Device 404.

Non-SuperSpeed channel 408 contains information for the synchronisation and triggering of USB Device 404. Clock synchronisation circuitry 412 generates a local clock syntonised and synchronised to the USB. Trigger detection circuitry 414 allows detection of PING (and possibly Data) messages addressed to a given endpoint of a given attached USB Device. This allows reception of a trigger event from another device with minimal latency.

The USB 3.0 specification defines that operation a SuperSpeed compliant device must first try to connect to a SuperSpeed host and failing that connect via a non-SuperSpeed host. The specification dictates that once a connection is made to a SuperSpeed host, the non-SuperSpeed device must not be connected and therefore the USB hub disables signalling on the non-SuperSpeed connection 408. However it is possible for a device to remain compliant but use a non-SuperSpeed synchronisation channel.

Consider the case of connecting the SuperSpeed device function and then disconnecting the non-SuperSpeed device function from the non-SuperSpeed bus. The USB Device may then connect pull up resistors to the USB D+/D− signalling lines in order to turn the upstream hub port on and allow broadcast data to be received by the Device.

Given the separation of the communication channel (data transmission) and clock/triggering information, non-SuperSpeed channel can be optimised for the lowest possible triggering latency.

In the preferred embodiment disclosed above the lowest triggering latency requires Host 402 to continually PING the trigger device while all other attached devices monitor the USB for a cessation of the PING message and possibly an associated Data Packet to the specified endpoint. (Cessation of the PING message may be enough to indicate a trigger, or reception of said data packet may be required to indicate a trigger, depending on the implementation).

Filling the available bandwidth of the non-SuperSpeed USB 408 with PING transactions is the ideal case. This obviously still allows Start of Frame packets to be used to deliver the clock information (as well as round trip propagation time signals being used in an initialisation phase to determine clock phase offsets and to define synchronisation). Separation of communications into the SuperSpeed channel allows the entire bandwidth of the non-SuperSpeed channel to be used for low latency triggering.

Non-SuperSpeed channel 408 is preferably a High Speed USB connection because it allows greater clock reference frequency (SOF rate) and also lower latency trigger times due to the higher signalling rate.

In this way a plurality of USB Devices 404 can be attached to the same USB creating a high throughput, tightly synchronised USB with low triggering latency, with very high data bandwidth via SuperSpeed USB and Clock and Synchronisation and Triggering capability delivered across non-SuperSpeed USB.

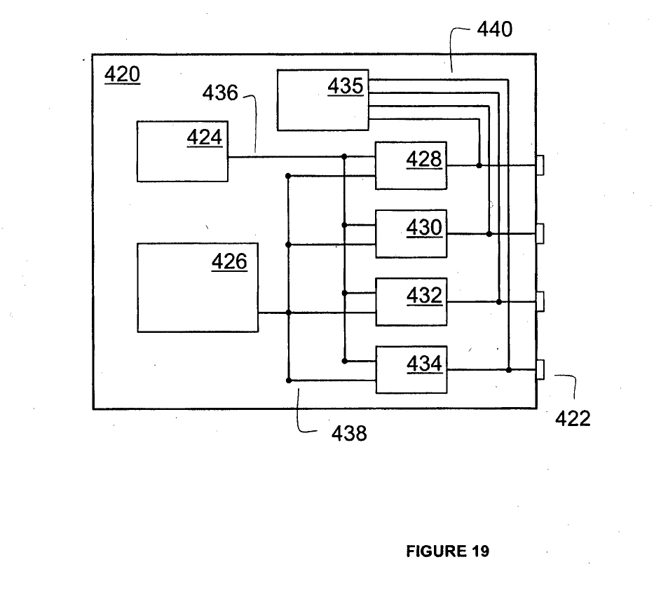

FIG. 19 is a schematic representation of a Synchronised Multi-Host USB at 420. Synchronised Multi-Host USB 420 contains a plurality of ports 422, each of which is a separate USB, derived from an independent USB Host Controller. Clock source 424 and System Controller 426 both control the operation of a plurality of Host Controllers 428, 430, 432, 434 via clock bus 436 and data bus 438. A multi-host USB system allows greater device count than a single USB Host Controller and greater total data bandwidth, but in order to correlate measurement from a plurality of measurement instruments across the plurality of hosts contained therein, each of said Host Controllers must be synchronised.

It is important that each of said Host Controllers operate at the same frequency because USB devices attached to each of the plurality of Host Controllers syntonise their clocks to the frame rate of said respective Host Controllers. Furthermore and non-obviously, each of said plurality of Host Controllers must synchronously initiate their frame counters because an attached USB Device's notion of time is related to the time at which it receives its respective numbered SOF tokens.

The present invention further provides a method of determining the propagation time of SOF tokens from each of said USB Host Controllers to each of said respective USB Devices, thereby allowing accurate control of the phase of each of said plurality of USB devices. Compared to prior art, the method and apparatus of the present invention does not require insertion of a message propagation measuring USB Hub.

In an additional preferable embodiment, an SOF comparison means is provided that measures the time of passage of said numbered SOF packets from each of said plurality of USB Host Controllers. Said comparison allows accurate phase compensation of each respective USB Host Controller's attached USB devices should said plurality of USB Host Controllers fail to initiate their frame counters synchronously. Therefore SOF detector 435 is configured to observe the communication traffic from each of said Host Controllers 428, 430, 432, 434 substantially near their downstream ports 422 via a bus 440 which is preferably propagation matched.

Each of said Host Controllers 428, 430, 432, 434 operate at the same frequency and their operation is started synchronously so that frame boundaries are phase aligned and frame numbers are identical. hi a preferred embodiment, each of said Host Controllers 428, 430, 432, 434 are SuperSpeed capable Host Controllers with signalling comparable to the method taught at FIG. 18, namely data communication managed by the SuperSpeed channel 406 with synchronisation and triggering managed by the non-SuperSpeed channel 408.

In a yet another preferred embodiment, Synchronised Multi-Host USB 420 is implemented as a PXI card allowing synchronisation of the Multi-Host USB to an external PXI timebase. Preferably other externally derived timebase such as GPS time, the timebase of an atomic clock, stable oscillator or IEEE-1588 time may also be used.

In this way, a single PXI card can contain a plurality of synchronised non-SuperSpeed USB busses whose combined data throughput is comparable to the throughput of a PXI backplane. Furthermore if

SuperSpeed USBs are synchronised in this manner a very high throughput synchronous USB can be deployed with data mapped directly to a plurality of Random Access Memories (RAM) additionally contained within Synchronised Multi-Host USB 420.

In yet another preferred embodiment, System Controller 426 acts as a plurality of synchronous Host Controllers with 428, 430, 432, 434 merely acting as USB Physical Layer Transceivers.

Modifications within the spirit and scope of the invention may be readily effected by those skilled in the art. It is to be understood, therefore, that this invention is not limited to the particular embodiments described by way of example hereinabove. It is the intention of this specification that the various embodiments described herein will be combined as desired to provide combinations of the various features. For the purposes of this specification it should be understood that the word “comprising” means “including but not limited to”, and that the word “comprises” has a corresponding meaning.

It should also be understood that “Personal Computer (PC)” and “Computer” represent a general computing device, be it personal computer, mainframe, mobile computing device, smartphone, test equipment or other computing device. Also, it is to be understood that unless the context requires otherwise, “Host Controller” refers to a standard USB Host Controller, a USB-on-the-go Host Controller, a wireless USB Host Controller or any other form of USB Host Controller.

Further, any reference herein to prior art is not intended to imply that such prior art forms or formed a part of the common general knowledge.

1-114. (canceled)

115. A method of determining a propagation time of signals from a USB Host Controller to an attached USB device, comprising:
said USB device sending a message or data packet to said USB Host Controller;
said USB device starting a local timer upon transmission of said message or data packet;
said USB Host Controller responding to said message or data packet by issuing a handshake token; and
said USB device stopping said local timer on receipt of said handshake token;
wherein said local timer value represents twice the propagation time of signals from said USB Host Controller to said USB device.

116. A method as claimed in claim 115, wherein said message or data packet comprises an intentionally corrupted data packet and said handshake token comprises a not acknowledge (NAK) token.

117. A method as claimed in claim 115, wherein said message or data packet comprises an ordinary data packet and said handshake token comprises either an acknowledge (ACK) token or a not acknowledge (NAK) token.

118. A method as claimed claims 115, further comprising:
repeating said method on an intermittent or periodic basis.

119. A method as claimed in claim 118, further comprising:
statistically analysing said timer values from each repetition of said method to obtain a statistically improved value of propagation time.

120. A method as claimed in claim 118, further comprising:
updating said determination of propagation time from each repetition of said method to track the drift in said propagation time.

121. A method as claimed in claim 115, further comprising:
syntonising the local clock of said USB device to the clock rate of said USB Host Controller before determining the propagation time of signals from the USB Host Controller to the attached USB device.

122. A method as claimed in claim 115, further comprising:
syntonising the local clock of said USB device to an external clock reference.

123. A method as claimed claim 115 wherein said timer is clocked from a clock source that is syntonised to a USB clock rate.

124. A method as claimed claim 115, further comprising:
said USB device transmitting said timer value to said USB Host Controller on request from said Host Controller.

125. A method as claimed in claim 124, wherein:
said transmitted timer value corresponds to either a single determination of propagation time or the accumulation of a known plurality of such propagation determinations.

126. An apparatus for measuring a round trip time of USB transactions between a USB device and a USB Host Controller, comprising:
circuitry for attaching to a USB;
circuitry adapted to transmit a data packet to said Host Controller across said USB; and
counter/timer circuitry for measuring a round trip time comprising a period of time between transmission of said data packet and reception of a response from said Host Controller.

127. An apparatus as claimed in claim 126, further comprising circuitry for syntonising a clock of said apparatus with a clock rate of the USB or Host Controller.

128. An apparatus as claimed in claim 126, wherein said circuitry adapted to transmit a data packet is configured to intentionally corrupt said specified data packet.

129. An apparatus as claimed in claim 128, wherein said circuitry adapted to transmit said data packet operates in parallel with a conventional USB device circuit, wherein:
said circuitry monitors USB transactions between the USB Host Controller and said conventional USB device circuitry; and
said circuitry is adapted to clamp signal levels on the USB during transmission of certain packets in order to intentionally corrupt an otherwise normal data packet.
